(19) United States
(12) Patent Application Publication
(10) Pub. No.: US 2017/0145187 A1
(43) Pub. Date: May 25, 2017

(54) PLASTICIZER COMPOSITION WHICH CONTAINS ALIPHATIC DICARBOXYLIC ACID ESTERS UND TEREPHTHALIC ACID DIALKYL ESTERS

(71) Applicant: BASF SE, Ludwigshafen (DE)

(72) Inventors: Matthias PFEIFFER, Böhl-lggelheim (DE); Boris BREITSCHEIDEL, Waldsee (DE); Axel GRIMM, Edenkoben (DE); Herbert MORGENSTERN, Ellerstadt (DE)

(21) Appl. No.: 15/323,584

(22) PCT Filed: Jul. 7, 2015
(86) PCT No.: PCT/EP2015/065421

§ 371 Date: Jan. 3, 2017

(30) Foreign Application Priority Data
Jul. 8, 2014 (EP) 14176144.5
Jan. 30, 2015 (EP) 15153263.7

(51) Int. Cl. C08K 5/12; C08K 5/11

(52) U.S. Cl. CPC C08K 5/12; C08K 5/11

(57) ABSTRACT

The invention relates to a plasticizer composition containing at least one aliphatic dicarboxylic acid ester and at least one terephthalic acid dialkyl ester, to molding compounds containing a thermoplastic polymer or an elastomer and a plasticizer composition of said type, and to the use of said plasticizer compositions and molding compounds.

### CROSS-REFERENCE TO RELATED APPLICATIONS

This application is a national stage application (under 35 U.S.C. §371) of PCT/EP2015/065421, filed Jul. 7, 2015, which claims benefit of European Application Nos. 14176144.5, filed Jul. 8, 2014, and 15153263.7, filed Jan. 30, 2015, all of which are incorporated herein by reference in their entirety.

### BACKGROUND OF THE INVENTION

The present invention relates to a plasticizer composition which comprises at least one aliphatic dicarboxylic ester and at least one dialkyl terephthalate, to molding compositions which comprise a thermoplastic polymer or an elastomer and this plasticizer composition, and to the use of these plasticizer compositions and molding compositions.

### PRIOR ART

Desired processing properties or desired performance properties are achieved in many plastics by adding what are known as plasticizers, in order to render the plastics softer, more flexible and/or more extensible. In general, the use of plasticizers serves to shift the thermoplastic range of plastics toward lower temperatures, so that the desired elastic properties are obtained in the region of low processing temperatures and service temperatures.

Production quantities of polyvinyl chloride (PVC) are among the highest of any plastic. Because of the versatility of this material, it is nowadays found in a wide variety of products used in everyday life. PVC therefore has very great economic importance. Intrinsically, PVC is a plastic which is hard and brittle at up to about 80° C., and is used in the form of rigid PVC (PVC-U) by addition of heat stabilizers and other adjuvants. Flexible PVC (PVC-P) is obtained only by adding suitable plasticizers, and can be used for many applications for which rigid PVC is unsuitable.

Examples of other important thermoplastic polymers in which plasticizers are usually used are polyvinyl butyral (PVB), homopolymers and copolymers of styrene, polyacrylates, polysulfides, or thermoplastic polyurethanes (PU).

The suitability of a substance for use as a plasticizer for a particular polymer depends largely on the properties of the polymer that is to be plasticized. The desire is generally for plasticizers which enjoy high compatibility with the polymer to be plasticized, i.e., which endow it with good thermoplastic properties, and which possess only low propensity to evaporation and/or exudation (high permanence).

A host of different compounds are available on the market for the plasticizing of PVC and other plastics. On account of their high compatibility with PVC and because of their advantageous performance properties, phthalic diesters with alcohols of various chemical structures have been much used in the past as plasticizers, examples being diethylhexyl phthalate (DEHP), diisononyl phthalate (DINP), and diisodecyl phthalate (DIDP). Short-chain phthalates, e.g. dibutyl phthalate (DIBP), diisobutyl phthalate (DIBP), benzyl butyl phthalate (BBP) or diisoheptyl phthalate (DIHP), are also used as fast fusers, for example in the production of what are known as plastisols. It is also possible to use dibenzoic esters, such as dipropylene glycol dibenzoates, for the same purpose alongside the short-chain phthalates. Phenyl and cresyl esters of alkylsulfonic acids are examples of another class of plasticizers with good gelling properties, and are obtainable with trademark Mesamoll®.

Plastisols initially are a suspension of finely pulverulent plastics in liquid plasticizers. The solvation rate of the polymer in the plasticizer here is very low at ambient temperature. The polymer is noticeably solvated in the plasticizer only on heating to relatively high temperatures. The individual isolated polymer aggregates here swell and fuse to give a three-dimensional high-viscosity gel. This procedure is termed gelling, and begins at a certain minimum temperature which is termed gel point or solvation temperature. The gelling step is not reversible.

Since plastisols take the form of liquids, they are very often used for the coating of a very wide variety of materials, e.g. textiles, glass nonwovens, etc. This coating is very often composed of a plurality of sublayers.

In a procedure often used in the Industrial processing of plastisols, a layer of plastisol is therefore applied and directly thereafter the plastic, in particular PVC, with the plasticizer is subjected to incipient gelling above the solvation temperature, thus producing a solid layer composed of a mixture of gelled, partially gelled, and ungelled polymer particles. The next sublayer is then applied to this incipiently gelled layer, and once the final layer has been applied the entire structure is processed in its entirety to give the fully gelled plastics product by heating to relatively high temperatures.

Another possibility, alongside production of plastisols, is production of dry pulverulant mixtures of plasticizer and polymers. These dry blends, in particular based on PVC, can then be further processed at elevated temperatures for example by extrusion to give pellets, or processed through conventional shaping processes, such as injection molding, extrusion, or calendering, to give the fully gelled plastics product.

Plasticizers with good gelling properties are additionally required because of increasing technical and economic demands on the processing of thermoplastic polymers and elastomers.

In particular in the production and processing of PVC plastisols, for example for producing PVC coatings, it is inter alia desirable to have available, as fast fuser, a plasticizer with low gelling point. High storage stability of the plastisol is moreover also desirable, i.e. the ungelled plastisol is intended to exhibit no, or only a slight, viscosity rise over the course of time at ambient temperature. As far as possible, these properties are intended to be achieved by addition of a suitable plasticizer with rapid-gelling properties, with no need for the use of other viscosity-reducing additives and/or of solvents.

However, fast fusers generally often have unsatisfactory compatibility with the additized polymers. Moreover, they usually exhibit high volatility both on processing and in use of the final products. Moreover, the addition of fast fusers in many cases has a deleterious effect on the mechanical properties of the final products. Another known method for establishing the desired plasticizer properties is therefore to use mixtures of plasticizers, e.g. at least one plasticizer which provides good thermoplastic properties but provides relatively poor gelling, in combination with at least one fast fuser.

Furthermore, there is a need to replace at least some of the aforementioned phthalate plasticizers, given that they are suspected of being injurious to health. This is especially so for sensible areas of application, such as children's toys, food packaging, or medical articles.

Known in the prior art are a variety of alternative plasticizers with different properties for a diversity of plastics, and especially for PVC.

One class of plasticizer known from the prior art, and able to be used as an alternative to phthalates, is based on cyclohexanepolycarboxylic acids, as described in WO 99/32427. In contrast to their unhydrogenated aromatic analogs, these compounds are toxicologically unobjectionable and can be used even in sensitive areas of application.

WO 00/78704 describes selected dialkyl cyclohexane-1,3- and -1,4-dicarboxylic esters for use as plasticizers in synthetic materials.

U.S. Pat. No. 7,973,194 B1 teaches the use of dibenzyl cyclohexane-1,4-dicarboxylate, benzyl butyl cyclohexane-1,4-dicarboxylate, and dibutyl cyclohexane-1,4-dicarboxylate as fast-gelling plasticizers for PVC.

Another known measure for setting the desired plasticizer properties is to use mixtures of plasticizers—for example, at least one plasticizer which imparts good thermoplastic properties but does not gel so well, in combination with at least one plasticizer which imparts good gelling properties.

WO 03/029339 discloses PVC compositions comprising cyclohexanepolycarboxylic esters, and also mixtures of cyclohexanepolycarboxylic esters with other plasticizers. Suitable other plasticizers stated are ester plasticizers, such as terephthalic esters, phthalic esters, isophthalic esters, and adipic esters. Further disclosed are PVC compositions comprising mixtures of cyclohexanepolycarboxylic esters with various fast-gelling plasticizers. Suitable fast-gelling plasticizers mentioned are, in particular, various benzoates, aromatic sulfonic esters, citrates, and also phosphates. Short-chain dicarboxylic esters, such as di-n-butyl adipate, are also mentioned in passing as suitable fast-gelling plasticizers.

Another class of plasticizer known from the prior art, and able to be used as alternatives to phthalates, is that of esters of terephthalic acid, as described in WO 2009/095126, for example.

EP 1354867 describes isomeric isononyl benzoates, mixtures thereof with alkyl phthalates, alkyl adipates, or alkyl cyclohexanedicarboxylates, and a process for preparing them. EP 1354867 further describes the use of said mixtures as plasticizers in plastics, especially in PVC and PVC plastisols. In order to achieve a gelling temperature sufficiently low for plastisol applications, large amounts of these isononyl benzoates have to be used. These plasticizers, moreover, exhibit a high volatility, and adding them is detrimental to the mechanical properties of the final products.

EP 1415978 describes isomeric isodecyl benzoates, mixtures thereof with alkyl phthalates, alkyl adipates, or alkyl cyclohexanedicarboxylates, and the use of these mixtures as plasticizers for polymers, particularly as plasticizers for PVC and PVC plastisols. In order to achieve a gelling temperature sufficiently low for plastisol applications, it is necessary here as well to use large amounts of these isodecyl benzoates. Moreover, these plasticizers likewise exhibit high volatility, and adding them is detrimental to the mechanical properties of the final products.

It is an object of the present invention to provide a plasticizer composition for thermoplastic polymers and elastomers which endows the composition on the one hand with good thermoplastic and mechanical properties and on the other hand with good gelling properties, i.e., a low gelling temperature. The plasticizer composition is intended as a result to be suitable particularly for the provision of plastisols. The plasticizer composition is to exhibit high compatibility with the polymer to be plasticized, is to possess high permanence, and is, moreover, to be toxicologically unobjectionable. Moreover, the Intention is that the plasticizer composition shall exhibit low volatility both on processing and during use of the final products—that is, it is to show little or no propensity toward exudation or evaporation. The polymers plasticized accordingly are thus to retain their elastic properties over a long period of time.

This object is surprisingly achieved by a plasticizer composition comprising
a) at least one compound of the general formula (I),

R¹—O—C(═O)—X—C(═O)—O—R² (I)
in which
X is an unbranched or branched C₂-C₈ alkylene group or an unbranched or branched C₂-C₈ alkenylene group, comprising at least one double bond
and
R¹ and R² independently at each occurrence are selected from C₃-C₅ alkyl,
b) at least one compound of the general formula (II),

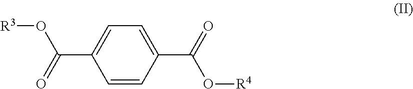

in which R³ and R⁴ independently of one another are selected from branched and unbranched C₄-C₁₂ alkyl radicals.

A further subject of the invention are molding compositions which comprise at least one thermoplastic polymer or elastomer and a plasticizer composition as defined above and hereinafter.

A further subject of the invention is the use of a plasticizer composition as defined above and hereinafter as plasticizer for thermoplastic polymers, more particularly polyvinyl chloride (PVC), and elastomers.

A further subject of the invention is the use of a plasticizer composition as defined above and hereinafter as plasticizer in plastisols.

A further subject of the invention is the use of these molding compositions for producing moldings and foils.

### A BRIEF DESCRIPTION OF THE FIGURES

FIG. 1 shows the gelling performance of PVC plastisols with a total fraction of inventive plasticizer composition of 100 phr in each case. The plot is of the complex viscosity η* [Pa·s] of the plastisols as a function of the temperature [° C.]. Plasticizer compositions used contained the commercially available plasticizer DOTP (Eastman 168™) and the fast fuser DBA (di-n-butyl adipate) in various proportions. Shown additionally for comparison is the gelling performance of PVC plastisols containing exclusively the commercially available plasticizers DOTP (Eastman 168™) or DINP (Palatinol® N).

FIG. 2 shows the gelling performance of PVC plastisols comprising as their plasticizers specific blends of DOTP (Eastman 168™) with the fast fuser DBA (di-n-butyl adipate) and the commercially available fast fusers INB (Vestinol® INB) or IDB (Jayflex® MB 10). The plot is of the complex viscosity η* [Pa·s] of the plastisols as a function of the temperature [° C.]. The fraction of the fast fuser in the plasticizer mixtures is selected such that the gelling temperature of DINP (Palatinol® N) is attained. Plotted additionally for comparison is the gelling performance of PVC plastisols containing exclusively the commercially available plasticizers DOTP (Eastman 168™) or DINP (Palatinol® N). The total plasticizer content of the plastisols is 100 phr.

FIG. 3 shows the process volatility of PVC plastisols containing 60 phr of the inventive plasticizer composition and also various blends of DOPT (Eastman 168™) with the commercially available fast fusers INB (Vestinol® INB) or IDB (Jayflex® MB 10). The plot is of the weight loss of the plastisols in % after a gelling time of 2 minutes at 190° C. Plotted additionally is the process volatility of PVC plastisols containing exclusively the commercially available plasticizers DOTP (Eastman 168™) or DINP (Palatinol® N).

FIG. 4 shows the Shore A hardness of PVC foils produced from PVC plastisols comprising 60 phr of the inventive plasticizer composition and also various blends of DOTP (Eastman 168™) with the commercially available fast fusers INB (Vestinol® INB) or IDB (Jayflex® MB 10). Plotted additionally is the Shore A hardness of foils produced from PVC plastisols comprising exclusively the commercially available plasticizers DOTP (Eastman 168™) or DINP (Palatinol® N). The Shore A hardness was measured in accordance with DIN EN ISO 868 from October 2003 after a measuring time of 15 seconds in each case.

FIG. 5 shows the foil volatility of PVC foils produced from plastisols comprising 60 phr of the inventively employed plasticizer composition and also various blends of DOTP (Eastman 168™) with the commercially available fast fusers INB (Vestinol® INB) or IDB (Jayflex® MB 10). The plot is of the weight loss of the PVC foils in %. Plotted additionally is the foil volatility of PVC foils produced from plastisols comprising exclusively the commercially available plasticizers DOTP (Eastman 168™) or DINP (Palatinol® N).

FIG. 6 shows the elongation at break of PVC foils produced from plastisols comprising 60 phr of the inventively employed plasticizer composition and also various blends of DOTP (Eastman 168™) with the commercially available fast fusers INB (Vestinol® INB) or IDB (Jayflex® MB 10).

FIG. 7 shows the storage stability of PVC foils produced from plastisols comprising 60 phr of the inventively employed plasticizer composition and also various blends of DOTP (Eastman 168™) with the commercially available fast fusers INB (Vestinol® INB) or IDB (Jayflex® MB 10). The plot is of the loss of dry weight [%] as a function of the storage time [d].

### DESCRIPTION OF THE INVENTION

The plasticizer compositions of the invention have at least one of the following advantages:
The plasticizer compositions of the invention are notable for high compatibility with the polymers to be plasticized, more particularly PVC.
The plasticizer compositions of the invention have high permanence, i.e., they show no tendency, or only a slight tendency, to exude or evaporate both in processing and during the service of the end products. Nevertheless, they impart good gelling properties to the polymer to be plasticized.
The plasticizer compositions of the Invention are suitable advantageously for the attainment of a multiplicity of very different and complex processing properties and performance properties of plastics.
The plasticizer composition of the invention is suitable advantageously for producing plastisols.
The compounds (I) present in the plasticizer composition of the invention are very highly suitable as fast fusers on account of their extremely low solvation temperatures in accordance with DIN 53408. To reduce the temperature needed for the gelling of a thermoplastic polymer and/or to increase the rate of gelling thereof, just small qualities of the compounds (I) in the plasticizer composition of the invention are enough.
The plasticizer composition of the invention are suitable for use for the production of moldings and films for sensitive areas of application, such as medical products, food packaging, products for the interior sector, of dwellings and vehicles, for example, toys, childcare articles, etc.
The compounds (I) present in the plasticizer compositions of the invention can be produced using readily available starting materials.
The processes for the preparation of the compounds (I) used in accordance with the invention are simple and efficient, allowing them to be provided readily on an industrial scale.

As mentioned above it has surprisingly been ascertained that the compounds of the general formula (I) present in the plasticizer compositions used in accordance with the invention have very low DIN 53408 solvation temperatures and as a result are especially suitable in combination with dialkyl terephthalates of the general formula (II) for improving the gelling performance of thermoplastic polymers and elastomers. Even relatively small amounts of the compounds (I) are sufficient in the plasticizer composition of the invention to lower the required gelling temperature and/or to increase the gelling rate.

For the purposes of the present invention, a “fast fuser” is a plasticizer having a DIN 53408 solvation temperature of below 120° C. Fast fusers of this kind are used particularly for producing plastisols.

For the purposes of the present invention, the abbreviation phr (parts per hundred resin) used above or below stands for parts by weight per hundred parts by weight of polymer.

The radicals R¹ and R² in the general formula (I) independently of one another are C₃ to C₅ alkyl. For the purposes of the present invention, the expression “C₃ to C₅ alkyl” encompasses straight-chain or branched C₃ to C₅ alkyl groups. They include n-propyl, isopropyl, n-butyl, isobutyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl and 1-ethylpropyl. With preference the radicals R¹ and R² in the general formula (I) independently of one another are n-butyl, isobutyl, n-pentyl, 2-methylbutyl or 3-methylbutyl. Very preferably the radicals R¹ and R² in the general formula (I) are both n-butyl.

For the purposes of the present invention, the expression “C₂-C₈ alkylene group” refers to divalent hydrocarbon radicals having 2 to 8 carbon atoms. The divalent hydrocarbon radicals may be unbranched or branched. They include, for example, 1,2-ethylene, 1,2-propylene, 1,3-propylene, 1,3-butylene, 1,4-butylene, 2-methyl-1,3-propylene, 1,1-dimethyl-1,2-ethylene, 1,4-pentylene, 1,5-pentylene, 2-methyl-1,4-butylene, 2,2-dimethyl-1,3-propylene, 1,6-hexylene, 2-methyl-1,5-pentylene, 3-methyl-1,5-pentylene, 2,3-dimethyl-1,4-butylene, 1,7-heptylene, 2-methyl-1,6-hexylene, 3-methyl-1,6-hexylene, 2-ethyl-1,5-pentylene, 3-ethyl-1,5-pentylene, 2,3-dimethyl-1,5-pentylene, 2,4-dimethyl-1,5-pentylene, 1,8-octylene, 2-methyl-1,7-heptylene, 3-methyl-1,7-heptylene, 4-methyl-1,7-heptylene, 2-ethyl-1,6-hexylene, 3-ethyl-1,6-hexylene, 2,3-dimethyl-1,6-hexylene, 2,4-dimethyl-1,6-hexylene, and the like. Preferably the “C₂-C₈ alkylene group” comprises unbranched C₂-C₅-alkylene groups, more particularly 1,3-propylene and 1,4-butylene.

For the purposes of the present invention, the “C₂-C₈ alkenylene group” comprises divalent hydrocarbon radicals having 2 to 8 carbon atoms, which may be unbranched or branched, with the main chain having at least one double bond. The “C₂-C₈ alkenylene group” preferably comprises branched and unbranched C₂-C₆ alkenylene groups having one double bonds. These include, for example, ethenylene, propenylene, 1-methylethenylene, 1-, 2-butenylene, 1-methylpropenylene, 2-methylpropenylene, 1-, 2-pentenylene, 1-methyl-1-butenylene, 1-methyl-2-butenylene, 1-, 2-, 3-hexenylene, 1-methyl-1-pentenylene, 1-methyl-2-pentenylene, 1-methyl-3-pentenylene, 1,4-dimethyl-1-butenylene, 1,4-dimethyl-2-butenylene, and the like. With particular preference the “C₂-C₈ alkenylene group” comprises unbranched C₂-C₄ alkenylene groups having one double bond.

The double bonds in the C₂-C₈ alkenylene groups may independently of one another be present in the E- and in Z-configuration or as a mixture of both configurations.

The singly or multiply branched C₂-C₈ alkylene groups and C₂-C₈ alkenylene groups may have an R or S configuration, or both configurations, in equal or different proportions, for the carbon atom at the branching point or for the carbon atoms at the respective branching points, independently of one another.

X in the compounds of the general formula (I) is preferably an unbranched C₂-C₅ alkylene group or an unbranched C₂-C₄ alkenylene group having one double bond.

More preferably, X in the compounds of the general formula (I) is an unbranched C₂-C₅ alkylene group, more particularly 1,3-propylene and 1,4-butylene.

Preferred compounds of the general formula (I) are selected from

Di(n-butyl) glutarate,
Diisobutyl glutarate,
Di(n-pentyl) glutarate,
Di(2-methylbutyl) glutarate,
Di(3-methylbutyl) glutarate,
Di(n-butyl) adipate,
Diisobutyl adipate,
Di(n-pentyl) adipate,
Di(2-methylbutyl) adipate,
Di(3-methylbutyl) adipate
and also mixtures of two or more than two of the aforesaid compounds.

One particularly preferred compound of the general formula (I) is di(n-butyl) adipate. Di(n-butyl) adipate is available commercially for example under the trade name Cetiol®B from BASF SE, Ludwigshafen.

In a further preferred embodiment, the radicals R³ and R⁴ in the compounds of the general formula (II) have the same definition.

With preference, in the compounds of the general formula (II), the radicals R³ and R⁴ are both C₇-C₁₂ alkyl, more preferably both 2-ethylhexyl, both isononyl, or both 2-propylheptyl.

A particularly preferred compound of the general formula (II) is di(2-ethylhexyl) terephthalate.

Through adaptation of the proportions of the compounds (I) and (II) in the plasticizer composition of the invention, the plasticizer properties may be tailored to the corresponding end use. For use in specific areas of application, it may optionally be useful to add further plasticizers, different from compounds (I) and (II), to the plasticizer composition of the invention. For this reason, the plasticizer composition of the invention may optionally comprise at least one further plasticizer, different from the compounds (I) and (II).

The additional plasticizer different from the compounds (I) and (II) is selected from phthalic dialkyl esters, phthalic alkylaryl esters, cyclohexane-1,2-dicarboxylic esters, cyclohexane-1,4-dicarboxylic esters, trimellitic trialkyl esters, benzoic alkyl esters, dibenzoic esters of glycols, hydroxybenzoic esters, esters of saturated monocarboxylic acids, esters of unsaturated dicarboxylic acids other than compounds (I), amides and esters of aromatic sulfonic acids, alkylsulfonic esters, glycerol esters, isosorbide esters, phosphoric esters, citric triesters, alkylpyrrolidone derivatives, 2,5-furandicarboxylic esters, 2,5-tetrahydrofurandicarboxylic esters, epoxidized vegetable oils and epoxidized fatty acid monoalkylesters, and polyesters of aliphatic and/or aromatic polycarboxylic acids with at least dihydric alcohols.

Suitable dialkyl phthalates which may be mixed advantageously with the compounds (I) and (II) independently of one another have 4 to 13 C atoms, preferably 8 to 13 C atoms, in the alkyl chains. A suitable alkyl aralkyl phthalate is benzyl butyl phthalate, for example. Suitable cyclohexane-1,2-dicarboxylic esters independently of one another have in each case 4 to 13 C atoms, more particularly 8 to 11 C atoms, in the alkyl chains. An example of a suitable cyclohexane-1,2-dicarboxylic ester is diisononyl cyclohexane-1,2-dicarboxylate. Suitable cyclohexane-1,4-dicarboxylic esters independently of one another have in each case 4 to 13 C atoms, more particularly 8 to 11 C atoms, in the alkyl chains. An example of a suitable cyclohexane-1,4-dicarboxylic ester is di-2-ethylhexyl 1,4-dicarboxylate. Suitable trimellitic acid trialkyl esters preferably have, independently of one another, in each case 4 to 13 C atoms, more particularly 7 to 11 C atoms, in the alkyl chains. Suitable benzoic acid alkyl esters preferably have, independently of one another, in each case 7 to 13 C atoms, more particularly 9 to 13 C atoms, in the alkyl chains. Suitable benzoic acid alkyl esters are, for example, isononyl benzoate, isodecyl benzoate, or 2-propylheptyl benzoate.

Suitable dibenzoic esters of glycols are diethylene glycol dibenzoate and dibutylene glycol dibenzoate. Suitable esters of saturated monocarboxylic acids are, for example, esters of acetic acid, butyric acid, valeric acid or lactic acid. Suitable esters of saturated dicarboxylic acids, different from the compounds of the formula (I), are, for example, esters of succinic acid, sebacic acid, lactic acid or tartaric acid, or esters of adipic acid having 6 to 13 C atoms in the alkyl radicals. Suitable esters of unsaturated dicarboxylic acids, different from the compounds of the formula (I), are, for example, esters of maleic acid and of fumaric acid having 6 to 13 C atoms in the alkyl radicals. Suitable alkylsulfonic esters preferably have an alkyl radical with 8 to 22 C atoms. They include, for example, phenyl or cresyl ester of pentadecylsulfonic acid. Suitable isosorbide esters are isosorbide diesters, which are preferably esterified with C₈-C₁₃ carboxylic acids. Suitable phosphoric esters are tri-2-ethylhexyl phosphate, trioctyl phosphate, triphenyl phosphate, isodecyl diphenyl phosphate, bis(2-ethylhexyl) phenyl phosphate, and 2-ethylhexyl diphenyl phosphate. In the citric triesters, the OH group may be present in free or carboxylated form, preferably acetylated. The alkyl radicals of the acetylated citric triesters preferably independently of one another have 4 to 8 C atoms, more particularly 6 to 8 C atoms. Alkylpyrrolidone derivatives having alkyl radicals of 4 to 18 C atoms are suitable. Suitable 2,5-Furandicarboxylic acid dialkyl esters have, independently of one another, in each case 7 to 13 C atoms, preferably 8 to 12 C atoms, in the alkyl chains. Suitable 2,5-tetrahydrofurandicarboxylic acid dialkyl esters have, independently of one another, in each case 7 to 13 C atoms, preferably 8 to 12 C atoms, in the alkyl chains. A suitable epoxidized vegetable oil is, for example, epoxidized soybean oil, available, for example, from Galata-Chemicals, Lampertheim, Germany. Epoxidized fatty acid monoalkyl esters, available, for example, under the trade name reFlex™ from PolyOne, USA are also suitable. The polyesters of aliphatic and aromatic polycarboxylic acids are preferably polyesters of adipic acid with polyhydric alcohols, more particularly dialkylene glycol polyadipates having 2 to 6 carbon atoms in the alkylene radical.

In all of the cases stated above, the alkyl radicals may in each case be linear or branched and in each case identical or different. Reference is made to the general observations given at the outset regarding suitable and preferred alkyl radicals.

The amount of the at least one further plasticizer, different from the compounds (I) and (II), in the plasticizer composition of the invention is typically 0 to 50 wt %, preferably 0 to 40 wt %, more preferably 0 to 30 wt %, and more particularly 0 to 25 wt %, based on the total amount of the at least one further plasticizer and of the compounds (I) and (II) in the plasticizer composition.

In one preferred embodiment the plasticizer composition of the invention comprises no further plasticizers different from the compounds (I) and (II).

The amount of compounds of the general formula (I) in the plasticizer composition of the invention is preferably 1 to 70 wt %, more preferably 2 to 50 wt %, and more particularly 3 to 30 wt %, based on the total amount of the compounds (I) and (II) in the plasticizer composition.

The amount of compounds of the general formula (II) in the plasticizer composition of the invention is preferably 30 to 99 wt %, more preferably 50 to 98 wt %, and more particularly 70 to 97 wt %, based on the total amount of the compounds (I) and (II) in the plasticizer composition.

In the plasticizer composition of the invention, the weight ratio between compounds of the general formula (I) and compounds of the general formula (II) is preferably in the range from 1:100 to 2:1, more preferably in the range from 1:50 to 1:1 and especially in the range from 1:35 to 1:2.

### Molding Compositions

A further subject of the present invention relates to a molding composition comprising at least one polymer and a plasticizer composition as defined above.

In one preferred embodiment, the polymer present in the molding composition comprises a thermoplastic polymer.

Thermoplastic polymers that are suitable include all polymers which can be processed thermoplastically. More particularly these thermoplastic polymers are selected from:
homopolymers or copolymers comprising in copolymerized form at least one monomer selected from C₂-C₁₀ monoolefins, such as, for example, ethylene or propylene, 1,3-butadiene, 2-chloro-1,3-butadiene, vinyl alcohol and its C₂-C₁₀ alkyl esters, vinyl chloride, vinylidene chloride, vinylidene fluoride, tetrafluoroethylene, glycidyl acrylate, glycidyl methacrylate, acrylates and methacrylates with alcohol components from branched and unbranched C₁-C₁₀ alcohols, vinylaromatics such as, for example, styrene, (meth)acrylonitrile, α,β-ethylenically unsaturated monocarboxylic and dicarboxylic acids, and maleic anhydride;
homopolymers and copolymers of vinyl acetals;
polyvinyl esters;
polycarbonates (PC);
polyesters, such as polyalkylene terephthalates, polyhydroxyalkenoates (PHA), polybutylenesuccinates (PBS), polybutylenesuccinate adipates (PBSA);
polyethers;
polyetherketones;
thermoplastic polyurethanes (TPU);
polysulfides;
polysulfones;
   and mixtures thereof.

Examples include polyacrylates with identical or different alcohol residues from the group of the C₄-C₈ alcohols, particularly those of butanol, hexanol, octanol, and 2 ethylhexanol, polymethyl methacrylate (PMMA), methyl methacrylate-butyl acrylate copolymers, acrylonitrile-butadiene-styrene copolymers (ABS), ethylene-propylene copolymers, ethylene-propylene-diene copolymers (EPDM), polystyrene (PS), styrene-acrylonitrile copolymers (SAN), acrylonitrile-styrene-acrylate (ASA), styrene-butadiene-methyl methacrylate copolymers (SBMMA), styrene-maleic anhydride copolymers, styrene-methacrylic acid copolymers (SMA), polyoxymethylene (POM), polyvinyl alcohol (PVAL), polyvinyl acetate (PVA), polyvinyl butyral (PVB), polycaprolactone (PCL), polyhydroxybutyric acid (PHB), polyhydroxyvaleric acid (PHV), polylactic acid (PLA), ethylcellulose (EC), cellulose acetate (CA), cellulose propionate (CP), or cellulose acetate/butyrate (CAB).

The at least one thermoplastic polymer present in the molding composition of the invention preferably comprises polyvinyl chloride (PVC), polyvinyl butyral (PVB), homopolymers and copolymers of vinyl acetate, homopolymers and copolymers of styrene, polyacrylates, thermoplastic polyurethanes (TPU), or polysulfides.

Depending on which thermoplastic polymer or thermoplastic polymer mixture is present in the molding composition, different amounts of plasticizer are used. Where the at least one thermoplastic polymer present in the molding composition of the invention is not PVC, the amount of the plasticizer composition of the invention in the molding composition is generally 0.5 to 300 phr (parts per hundred resin, i.e., parts by weight per hundred parts by weight of polymer), preferably 0.5 to 130 phr, more preferably 1 to 100 phr.

The at least one thermoplastic polymer present in the molding composition of the invention is especially polyvinyl chloride (PVC).

Polyvinyl chloride is obtained by homopolymerization of vinyl chloride. The polyvinyl chloride (PVC) used in accordance with the invention may be prepared, for example, by suspension polymerization, microsuspension polymerization, emulsion polymerization, or bulk polymerization. The preparation of PVC by polymerization of vinyl chloride, and production and composition of plasticized PVC, are described in, for example, “Becker/Braun, Kunststoff-Handbuch, volume 2/1: Polyvinylchlord”, 2^{nd} edition, Carl Hanser Verlag, Munich.

For the PVC plasticized in accordance with the invention, the K value, which characterizes the molar mass of the PVC and is determined according to DIN 53726, is usually in the range from 57 and 90, preferably in the range from 61 and 85, more particularly in the range from 64 and 80.

For the purposes of the invention, the amount of PVC in the molding compositions of the invention is 20 to 95 wt %, preferably 40 to 90 wt %, and more particularly 45 to 85 wt %.

Where the thermoplastic polymer in the molding compositions of the invention is polyvinyl chloride, the amount of the plasticizer composition of the invention in the molding composition is generally 1 to 300 phr, preferably 5 to 150 phr, more preferably 10 to 130 phr, and more particularly 15 to 120 phr.

A further subject of the present invention relates to molding compositions comprising at least one elastomer and at least one plasticizer composition as defined above.

The elastomer present in the molding compositions of the invention is preferably at least one natural rubber (NR), or at least one synthetically produced rubber, or mixtures thereof. Examples of preferred rubbers produced synthetically are polyisoprene rubber (IR), styrene-butadiene rubber (SBR), butadiene rubber (BR), nitrile-butadiene rubber (NBR), or chloroprene rubber (CR).

Preferred rubbers or rubber mixtures are those which can be vulcanized with sulfur.

For the purposes of the invention, the amount of elastomer in the molding compositions of the invention is 20% to 95 wt %, preferably is 45% to 90 wt %, and more particularly 50% to 85 wt %.

For the purposes of the invention, the molding compositions which comprise at least one elastomer may comprise other suitable adjuvants, in addition to the ingredients above. For example, there may be reinforcing fillers present, such as carbon black or silicon dioxide, further fillers, a methylene donor, such as hexamethylenetetramine (HMT), a methylene acceptor, such as phenolic resins modified with cardanol (from cashew nuts), a vulcanizing or crosslinking agent, a vulcanizing or crosslinking accelerator, activators, various types of oil, aging inhibitors, and other various adjuvants which are incorporated, for example, into tire compounds and other rubber compounds, for example.

Where the polymer in the molding compositions of the Invention comprises rubbers, the content of the plasticizer composition of the invention, as defined above, if the molding composition is 1 to 60 phr, preferably 1 to 40 phr, more preferably 2 to 30 phr.

### Molding Composition Adjuvants

For the purposes of the invention, the molding compositions comprising at least one thermoplastic polymer may comprise other suitable adjuvants. Examples that may be present include stabilizers, lubricants, fillers, pigments, flame retardants, light stabilizers, blowing agents, polymeric processing assistants, impact tougheners, optical brighteners, antistats, or biostabilizers.

A number of suitable adjuvants are described in more detail below. The examples given, however, do not impose any restriction on the molding compositions of the invention, but instead serve merely for elucidation. All amount details are in wt % figures, based on the molding composition as a whole.

Stabilizers contemplated include all customary PVC stabilizers in solid and liquid form, examples being customary Ca/Zn, Ba/Zn, Pb or Sn stabilizers, and also acid-binding phyllosilicates.

The molding compositions of the invention may have a stabilizer content of 0.05% to 7%, preferably 0.1% to 5%, more preferably of 0.2% to 4%, and more particularly of 0.5% to 3%.

Lubricants reduce the adhesion between the plastics to be processed and metal surfaces and ought to counteract frictional forces during mixing, plastifying, and deforming.

The molding compositions of the invention may comprise, as lubricants, all lubricants customary for the processing of plastics. Those contemplated include, for example hydrocarbons, such as oils, paraffins, and PE waxes, fatty alcohols having 6 to 20 carbon atoms, ketones, carboxylic acids, such as fatty acids and montanic acid, oxidized PE wax, metal salts of carboxylic acids, carboxamides, and also carboxylic esters, examples being those with the alcohols ethanol, fatty alcohols, glycerol, ethanediol, pentaerythritol, and long-chain carboxylic acids as acid component.

The molding compositions of the invention may have a lubricant content of 0.01% to 10%, preferably 0.05% to 5%, more preferably of 0.1% to 3%, and more particularly of 0.2% to 2%.

Fillers influence in particular the compressive strength, tensile strength, and flexural strength, and also the hardness and heat distortion resistance, of plasticized PVC in a positive way.

For the purposes of the invention, the molding compositions may also comprise fillers, such as, for example, carbon black and other organic fillers, such as natural calcium carbonates, as for example chalk, limestone, and marble, synthetic calcium carbonates, dolomite, silicates, silica, sand, diatomaceous earth, aluminum silicates, such as kaolin, mica, and feldspar. Preferred fillers used are calcium carbonates, chalk, dolomite, kaolin, silicates, talc, or carbon black.

The molding compositions of the invention may have a filler content of 0.01% to 80%, preferably 0.1 to 60%, more preferably of 0.5 to 50%, and more particularly of 1% to 40%.

The molding compositions of the invention may also comprise pigments, in order to adapt the resulting product to different possible applications.

For the purposes of the present invention, both inorganic pigments and organic pigments may be used. Inorganic pigments used may be, for example, cobalt pigments, such as CoO/AlO₃, and chromium pigments, as for example Cr₂O₃. Organic pigments contemplated include, for example, monoazo pigments, condensed azo pigments, azomethine pigments, anthraquinone pigments, quinacridones, phthalocyanine pigments and dioxazine pigments.

The molding compositions of the invention may have a pigment content of 0.01% to 10%, preferably 0.05% to 5%, more preferably of 0.1% to 3%, and more particularly of 0.5% to 2%.

In order to reduce flammability and to reduce the level of smoke given off on buming, the molding compositions of the invention may also comprise flame retardants.

Examples of flame retardants which can be used include antimony trioxide, phosphate esters, chlorinated paraffin, aluminum hydroxide or boron compounds.

The molding compositions of the invention may have a flame retardant content of 0.01% to 10%, preferably 0.1% to 8%, more preferably of 0.2% to 5%, and more particularly of 0.5% to 2%.

In order to protect articles produced from the molding compositions of the invention from surface-region damage due to the influence of light, the molding compositions may also comprise light stabilizers, for example, UV absorbers.

For the purposes of the present invention it is possible to use hydroxybenzophenones, hydroxyphenylbenzotriazoles, cyanoacrylates or what are known as hindered aminine light stabilizers (HALS) such as the derivatives of 2,2,6,6-tetramethylpiperidine, for example, as light stabilizers.

The molding compositions of the Invention may have a light stabilizer content, for example UV absorber, of 0.01% to 7%, preferably 0.1% to 5%, more preferably of 0.2% to 4%, and more particularly of 0.5% to 3%.

### Preparation of the Compounds of the General Formula (I)

Described below is the preparation of the compounds of the general formula (I) present in the plasticizer compositions of the invention.

### Esterification

The ester compounds of the general formula (I) can be prepared by esterification of corresponding aliphatic dicarboxylic acids with the corresponding aliphatic alcohols according to customary methods known to the skilled person. These include the reaction of at least one alcohol component, selected from the alcohols R¹—OH and/or R²—OH, with a dicarboxylic acid of the general formula HO—C(═O)—X—C(═O)—OH or a suitable derivative thereof. Examples of suitable derivatives are the acyl halides and acid anhydrides. One preferred acyl halide is the acyl chloride. Esterification catalysts used may be the catalysts customary for that purpose, examples being mineral acids, such as sulfuric acid and phosphoric add; organic sulfonic acids, such as methanesulfonic acid and p-toluenesulfonic acid; amphoteric catalysts, more particularly compounds of titanium, tin(IV) compounds, or zirconium compounds, such as tetraalkoxytitaniums, e.g., tetrabutoxytitanium, and tin(IV) oxide. The water formed in the reaction can be removed by customary measures, such as by distillation, for example. WO 02/38531 describes a process for preparing esters of polybasic carboxylic acids by a) heating to boiling, in a reaction zone, a mixture consisting essentially of the acid component or an anhydride thereof and of the alcohol component, in the presence of an esterifying catalyst, b) separating the alcohol and water containing vapors by rectification into an alcohol-rich fraction and a water-rich fraction, c) returning the alcohol-rich fraction to the reaction zone, and discharging the water-rich fraction from the process. The process described in WO 02/38531 and also the catalysts disclosed therein are likewise suitable for the esterification.

The esterification catalyst is used an effective amount, which is typically in the range from 0.05 to 10 wt %, preferably 0.1 to 5 wt %, based on the sum of acid component (or anhydride) and alcohol component.

Further suitable methods for preparing the compounds of the general formula (I) by means of esterification are described in, for example, U.S. Pat. No. 6,310,235, U.S. Pat. No. 5,324,853, DE-A 2612355 or DE-A 1945359. The documents cited are hereby referenced in full.

In general the esterification of the dicarboxylic acid HO—C(═O)—X—C(═O)—OH takes place in the presence of the above-described alcohol components R¹—OH and/or R²—OH by means of an organic acid or mineral acid, more particularly concentrated sulfuric acid. The alcohol component here is used advantageously in at least twice the stoichiometric amount, based on the amount of dicarboxylic acid HO—C(═O)—X—C(═O)—OH or a suitable derivative thereof in the reaction mixture.

The esterification may take place in general at ambient pressure or under reduced or elevated pressure. The esterification is preferably conducted at ambient pressure or reduced pressure.

The esterification can be carried out in the absence of an added solvent, or in the presence of an organic solvent.

If the esterification is carried out in the presence of a solvent, the solvent in question is preferably an organic solvent which is inert under the reaction conditions. Such solvents include, for example, aliphatic hydrocarbons, halogenated aliphatic hydrocarbons, aromatic and substituted aromatic hydrocarbons, or ethers. The solvent is selected preferably from pentane, hexane, heptanes, ligroin, petroleum ether, cyclohexane, dichloromethane, trichloromethane, carbon tetrachloride, benzene, toluene, xylene, chlorobenzene, dichlorobenzenes, dibutyl ether, THF, dioxane, and mixtures thereof.

The esterification is carried out customarily within a temperature range from 50 to 250° C.

Where the esterification catalyst is selected from organic acids or mineral acids, the esterification is conducted typically in a temperature range from 50 to 160° C.

Where the esterification catalyst is selected from amphoteric catalysts, the esterification is carried out customarily within a temperature range from 100 to 250° C.

The esterification may take place in the presence or absence of an inert gas. An inert gas, generally speaking, is a gas which under the existing reaction conditions, does not enter into any reactions with reactants participating in the reaction, or with reagents, or with solvents, or with the products formed.

### Transesterification:

Conventional processes known to the person skilled in the art can be used for the production of the ester compounds of the general formula (I) by transesterification of esters, which differ from the esters of the general formula (I), with the corresponding aliphatic alcohols. They include the reaction of the di(C₁-C₂)-alkyl esters of the dicarboxylic acids HO—C(═O)—X—C(═O)—OH with at least one alcohol R¹—OH and/or R²—OH, or mixtures thereof, in the presence of a suitable transesterification catalyst.

Transesterification catalysts that can be used are the conventional catalysts usually used for transesterification reactions, and mostly also used in esterification reactions. Among these are by way of example mineral acids, such as sulfuric acid and phosphoric acid; organic sulfonic acids, such as methanesulfonic acid and p-toluenesulfonic acid; and specific metal catalysts from the group of the tin(IV) catalysts, for example dialkyltin dicarboxylates, such as dibutyltin diacetate, trialkyltin alkoxides, monoalkyltin compounds, such as monobutyltin dioxide, tin salts, such as tin acetate, or tin oxides; from the group of the titanium catalysts: monomeric and polymeric titanates and titanium chelates, for example tetraethyl orthotitanate, tetrapropyl orthotitanate, tetrabutyl orthotitanate, triethanolamine titanate; from the group of the zirconium catalysts: zirconates and zirconium chelates, for example tetrapropyl zirconate, tetrabutyl zirconate, triethanolamine zirconate; and also lithium catalysts, such as lithium salts, lithium alkoxides; and aluminum(III) acetylacetonate, chromium(III) acetylacetonate, iron(III) acetylacetonate, cobalt(II) acetylacetonate, nickel(II) acetylacetonate, and zinc(II) acetylacetonate.

The amount of transesterification catalyst used is from 0.05 to 5% by weight, preferably from 0.1 to 1% by weight. The reaction mixture is preferably heated to the boiling point of the reaction mixture, the reaction temperature therefore being from 20° C. to 200° C., depending on the reactants.

The transesterification can take place at ambient pressure or at reduced or elevated pressure. It is preferable that the transesterification is carried out at a pressure of from 0.001 to 200 bar, particularly from 0.01 to 5 bar. The relatively low-boiling-point alcohol eliminated during the transesterification is preferably continuously removed by distillation in order to shift the equilibrium of the transesterification reaction. The distillation column necessary for this purpose generally has direct connection to the transesterification reactor, and it is preferable that said column is a direct attachment thereto. If a plurality of transesterification reactors are used in series, each of said reactors can have a distillation column, or the vaporized alcohol mixture can preferably be introduced into a distillation column from the final tanks of the transesterification reactor cascade by way of one or more collection lines. The relatively high-boiling-point alcohol reclaimed in said distillation is preferably returned to the transesterification.

If an amphoteric catalyst is used, this is generally removed via hydrolysis and subsequent removal of the resultant metal oxide, e.g. via filtration. It is preferable that, after reaction has been completed, the catalyst is hydrolyzed by means of washing with water, and the precipitated metal oxide is removed by filtration. The filtrate can, if desired, be subjected to further work-up for the isolation and/or purification of the product. It is preferable that the product is isolated by distillation.

The transesterification of the di(C₁-C₂)-alkyl esters of the dicarboxylic acids HO—C(═O)—X—C(═O)—OH with at least one alcohol R¹—OH and/or R²—OH, or mixtures thereof, preferably takes place in the presence of at least one titanium(IV) alcoholate. Preferred titanium(IV) alcoholates are tetrapropoxytitanium, tetrabutoxytitanium, and mixtures thereof. It is preferable that the amount used of the alcohol component is at least twice the stoichiometric amount, based on the di(C₁-C₂-alkyl) esters used.

The transesterification can be carried out in the absence of, or in the presence of, an added organic solvent. It is preferable that the transesterification is carried out in the presence of an inert organic solvent. Suitable organic solvents are those mentioned above for the esterification. Among these are specifically toluene and THF.

The transesterification is preferably carried out in the temperature range from 50 to 200° C.

The transesterification can take place in the absence of or in the presence of an inert gas. The expression inert gas generally means a gas which under the prevailing reaction conditions does not enter into any reactions with the starting materials, reagents, or solvents participating in the reaction, or with the resultant products. It is preferable that the transesterification takes place without addition of any inert gas.

The aliphatic dicarboxylic acids and aliphatic alcohols used in preparing the compounds of the general formula (I) may either be acquired commercially or prepared by synthesis routes that are known from the literature.

The inventive compound di-n-butyl adipate is also available commercially, for example under the trade name Cetiol® B from BASF SE, Ludwigstafen, and under the trade name Adimoll® DB from Lanxess, Leverkusen.

### Compounds of the General Formula (II)

The compounds of the general formula (II) may be either acquired commercially or prepared by methods known in the prior art.

In general the dialkyl terephthalates are obtained by esterification of terephthalic acid or suitable derivatives thereof with the corresponding alcohols. The esterification may take place by customary methods known to the skilled person.

A common feature of the methods for preparing the compounds of the general formula (II) is that starting from terephthalic acid or suitable derivatives thereof, an esterification or a transesterification is carried out, with the corresponding C₄-C₁₂-alkanols being used as reactants. These alcohols are generally not pure substances, but are instead isomer mixtures whose composition and degree of purity are dependent on the particular method by which they are prepared.

Preferred C₄-C₁₂ alkanols which are used in preparing the compounds (II) present in the plasticizer composition of the invention may be straight-chain or branched or may consist of mixtures of straight-chain and branched C₄-C₁₂ alkanols. They include n-butanol, isobutanol, n-pentanol, isopentanol, n-hexanol, isohexanol, n-heptanol, isoheptanol, n-octanol, isooctanol, 2-ethylhexanol, n-nonanol, isononanol, isodecanol, 2-propylheptanol, n-undecanol, isoundecanol, n-dodecanol or isododecanol. Particular preference is given to C₇-C₁₂ alkanols, in particular, 2-ethylhexanol, isononanol and 2-propylheptanol, especially 2-ethylhexanol.

Compounds of the general formula (II) are available commercially. An example of a suitable commercially available plasticizer of the general formula (II) is di(2-ethylhexyl) terephthalate (DOTP), which is marketed under the trade name Palatinol) DOTP from BASF, Florham Park, N.J., USA.

### Heptanol

The heptanols used in preparing the compounds of the general formula (II) may be straight-chain or branched or may consist of mixtures of straight-chain and branched heptanols. Preference is given to using mixtures of branched heptanols, also called isoheptanol, which are prepared by the rhodium-catalyzed, or preferably cobalt-catalyzed hydroformylation of dimer propene, obtainable for example by the Dimersol® process, and subsequent hydrogenation of the resulting isoheptanols to give an isoheptanol mixture. In accordance with its preparation, the isoheptanol mixture thus obtained consists of a plurality of isomers. Substantially straight-chain heptanols may be obtained by the rhodium-catalyzed or preferably cobalt-catalyzed hydroformylation of 1-hexene and subsequent hydrogenation of the resultant n-heptanol to n-heptanol. The hydroformylation of 1-hexene or dimer propene may take place according to processes known per se: In the case of the hydroformylation with rhodium catalysts dissolved homogeneously in the reaction medium, it is possible to use as catalyst not only noncomplexed rhodium carbonyls, which are formed in situ under the conditions of the hydroformylation reaction in the hydroformylation mixture under the action of synthesis gas, from rhodium salts, for example, but also complex rhodium carbonyl compounds, more particularly complexes with organic phosphines, such as triphenylphosphine, or organophosphates, preferably chelating biphosphites, as described in U.S. Pat. No. 5,288,918, for example. In the case of the cobalt-catalyzed hydroformylation of these olefins, cobalt carbonyl compounds are generally used which are homogeneously soluble in the reaction mixture and which form from cobalt salts under the conditions of the hydroformylation reaction under the action of synthesis gas. Where the cobalt-catalyzed hydroformylation is performed in the presence of trialkyl- or triarylphosphines, the desired heptanols are formed directly as the hydroformylation product, meaning that there is no further need for hydrogenation of the aldehyde function.

Examples of suitable processes for the cobalt-catalyzed hydroformylation of the 1-hexene or of the hexene isomer mixtures are those industrially established processes elucidated in Falbe, New Syntheses with Carbon Monoxide, Springer, Berlin, 1980, on pages 162-168, such as the Ruhrchemie process, the BASF process, the Kuhlmann process, or the Shell process. While the Ruhrchemie, BASF, and Kuhlmann processes operate with non-ligand-modified cobalt carbonyl compounds as catalysts, and produce hexanal mixtures, the Shell process (DE-A 1593368) uses phosphine or phosphite ligand-modified cobalt carbonyl compounds as catalyst, which by virtue of their additional high hydrogenation activity lead directly to the hexanol mixtures.

Advantageous embodiments for the implementation of the hydroformylation with non-ligand-modified cobalt carbonyl complexes are described in detail in DE-A 2139630, DE-A 2244373, DE-A 2404855, and WO 01014297.

The rhodium-catalyzed hydroformylation of 1-hexene or of the hexene isomer mixtures can use the established industrial low-pressure rhodium hydroformylation process with triphenylphosphine-ligand-modified rhodium carbonyl compounds, which is subject matter of U.S. Pat. No. 4,148,830. Non-ligand-modified rhodium carbonyl compounds can serve advantageously as catalyst for the rhodium-catalyzed hydroformylation of long-chain olefins, for example of the hexene isomer mixtures obtained by the processes described above; this differs from the low-pressure process in requiring a higher pressure of from 80 to 400 bar. The conduct of high-pressure rhodium hydroformylation processes of this type is described by way of example in EP-A 695734, EP-B 880494, and EP-B 1047655.

The isoheptanol mixtures obtained after hydroformylation of the hexene isomer mixtures are catalytically hydrogenated in a manner that is per se conventional to give isoheptanol mixtures. For this purpose it is preferable to use heterogeneous catalysts which comprise, as catalytically active component, metals and/or metal oxides of groups VI to VIII, or else of transition group I, of the Periodic Table of the Elements, in particular chromium, molybdenum, manganese, rhenium, iron, cobalt, nickel, and/or copper, optionally deposited on a support material such as Al₂O₃, SiO₂ and/or TiO₂. Catalysts of this type are described by way of example in DE-A 3228881, DE-A 2628987, and DE-A 2445303. It is particularly advantageous to carry out the hydrogenation of the isoheptanols with an excess of hydrogen of from 1.5 to 20% above the stoichiometric amount of hydrogen needed for the hydrogenation of the isoheptanols, at temperatures of from 50 to 200° C., and at a hydrogen pressure of from 25 to 350 bar, and for avoidance of side-reactions to add, during the course of the hydrogenation, in accordance with DE-A 2628987, a small amount of water, advantageously in the form of an aqueous solution of an alkali metal hydroxide or alkali metal carbonate, in accordance with the teaching of WO 01087809.

### Octanol

For many years, 2-ethylhexanol was the largest-production-quantity plasticizer alcohol, and it can be obtained through the aldol condensation of n-butyraldehyde to give 2-ethylhexenal and subsequent hydrogenation thereof to give 2-ethylhexanol (see Ullmann's Encyclopedia of Industrial Chemistry; 5^{th} edition, vol. A 10, pp. 137-140, VCH Verlagsgesellschaft GmbH, Weinheim 1987).

Substantially straight-chain octanols can be obtained via rhodium- or preferably cobalt-catalyzed hydroformylation of 1-heptene and subsequent hydrogenation of the resultant n-octanal to give n-octanol. The 1-heptene needed for this purpose can be obtained from the Fischer-Tropsch synthesis of hydrocarbons.

By virtue of the production route used for the alcohol isooctanol, it is not a unitary chemical compound, in contrast to 2-ethylhexanol or n-octanol, but instead is an isomer mixture of variously branched C₈ alcohols, for example of 2,3-dimethyl-1-hexanol, 3,5-dimethyl-1-hexanol, 4,5-dimethyl-1-hexanol, 3-methyl-1-heptanol, and 5-methyl-1-heptanol; these can be present in the isooctanol in various quantitative proportions which depend on the production conditions and production processes used. Isooctanol is usually produced via codimerization of propene with butenes, preferably n-butenes, and subsequent hydroformylation of the resultant mixture of heptene isomers. The octanal isomer mixture obtained in the hydroformylation can subsequently be hydrogenated to give the isooctanol in a manner that is conventional per se.

The codimerization of propene with butenes to give isomeric heptenes can advantageously be achieved with the aid of the homogeneously catalyzed Dimersol® process (Chauvin at al; Chem. Ind.; May 1974, pp. 375-378), which uses, as catalyst, a soluble nickel phosphine complex in the presence of an ethylaluminum chlorine compound, for example ethylaluminum dichloride. Examples of phosphine ligands that can be used for the nickel complex catalyst are tributylphosphine, triisopropyl-phosphine, tricyclohexylphosphine, and/or tribenzylphosphine. The reaction takes place at temperatures of from 0 to 80° C., and it is advantageous here to set a pressure at which the olefins are present in solution in the liquid reaction mixture (Cornils; Hermann: Applied Homogeneous Catalysis with Organometallic Compounds; 2^{nd} edition, vol. 1; pp. 254-259, Wiley-VCH, Weinheim 2002).

In an alternative to the Dimersol® process operated with nickel catalysts homogeneously dissolved in the reaction medium, the codimerization of propene with butenes can also be carried out with a heterogeneous NiO catalyst deposited on a support; heptene isomer distributions obtained here are similar to those obtained in the homogeneously catalyzed process. Catalysts of this type are by way of example used in what is known as the Octol® process (Hydrocarbon Processing, February 1986, pp. 31-33), and a specific heterogeneous nickel catalyst with good suitability for olefin dimerization or olefin codimerization is disclosed by way of example in WO 9514647.

Codimerization of propene with butenes can also use, instead of nickel-based catalysts, heterogeneous Brønsted-acid catalysts; heptenes obtained here are generally more highly branched than in the nickel-catalyzed processes. Examples of catalysts suitable for this purpose are solid phosphoric acid catalysts, e.g. phosphoric-acid-impregnated kieseguhr or diatomaceous earth, these being as utilized in the PolyGas® process for olefin dimerization or olefin oligomerization (Chitnis et al; Hydrocarbon Engineering 10, No. 6—June 2005). Brønsted-acid catalysts that have very good suitability for the codimerization of propene and butenes to give heptenes are zeolites, which are used in the EMOGAS® process, a further development based on the PolyGas® process.

The 1-heptene and the heptene isomer mixtures are converted to n-octanal and, respectively, octanal isomer mixtures by the known processes explained above in connection with the production of n-heptanol and heptanol isomer mixtures, by means of rhodium- or cobalt-catalyzed hydroformylation, preferably cobalt-catalyzed hydroformylation. These are then hydrogenated to give the corresponding octanols, for example by means of one of the catalysts mentioned above in connection with production of n-heptanol and of isoheptanol.

### Nonanol

Substantially straight-chain nonanol can be obtained via rhodium- or preferably cobalt-catalyzed hydroformylation of 1-octene and subsequent hydrogenation of the resultant n-nonanal. The starting olefin 1-octene can be obtained by way of example by way of ethylene oligomerization by means of a nickel complex catalyst that is homogenously soluble in the reaction medium—1,4-butanediol—with, for example, diphenyl-phosphinoacetic acid or 2-diphenylphosphinobenzoic acid as ligand. This process is also known as the Shell Higher Olefins Process or SHOP process (see Weisermel, Arpe: Industrielle Organische Chemie [Industrial organic chemistry]; 5^{th} edition, p. 96; Wiley-VCH, Weinheim 1998).

Isononanol which is used for the synthesis of the diisononyl esters of the general formula (II) comprised in the plasticizer composition of the invention, is not a unitary chemical compound, but instead is a mixture of variously branched, isomeric C₉-alcohols which can have various degrees of branching depending on the manner in which they were produced, and also in particular on the starting materials used. The isononanols are generally produced via dimerization of butenes to give isooctene mixtures, subsequent hydroformylation of the isooctene mixtures, and hydrogenation of the resultant isononanol mixtures to give isononanol mixtures, as explained in Ullmann's Encyclopedia of Industrial Chemistry, 5^{th} edition, vol. A1, pp. 291-292, VCH Verlagsgesellschaft GmbH, Weinheim 1995.

Both isobutene, cis- and trans-2-butene, and also 1-butene, or a mixture of these butene isomers, can be used as starting material for the production of the isononanols. The dimerization of pure isobutene, mainly catalyzed by means of liquid, e.g., sulfuric acid or phosphoric acid, or by means of solid, e.g., phosphoric acid applied to kieselguhr, SiO₂, or Al₂O₃, as support material, or zeolites, or Brønsted acids, mainly gives the highly branched compound 2,4,4-trimethylpentene, also termed diisobutylene, which gives highly branched isononanols after hydroformylation and hydrogenation of the aldehyde.

Preference is given to isononanols with a low degree of branching. Isononanol mixtures of this type with little branching are prepared from the linear butenes 1-butene, cis- and/or trans-2-butene, which optionally can also comprise relatively small amounts of isobutene, by way of the route described above involving butene dimerization, hydroformylation of the isooctene, and hydrogenation of the resultant isononanol mixtures. A preferred raw material is what is known as raffinate II, which is obtained from the C₄ cut of a cracker, for example of a steam cracker, after elimination of allenes, acetylenes, and dienes, in particular 1,3-butadiene, via partial hydrogenation thereof to give linear butenes, or removal thereof via extractive distillation, for example by means of N-methylpyrrolidone, and subsequent Brønsted-acid catalyzed removal of the isobutene comprised therein via reaction thereof with methanol or isobutanol by established large-scale-industrial processes with formation of the fuel additive methyl tert-butyl ether (MTBE), or of the isobutyl tert-butyl ether that is used to obtain pure isobutene.

Raffinate II also comprises, alongside 1-butene and cis- and trans-2-butene, n- and isobutane, and residual amounts of up to 5% by weight of isobutene.

The dimerization of the linear butenes or of the butene mixture comprised in raffinate II can be carried out by means of the familiar processes used on a large industrial scale, for example those explained above in connection with the production of isoheptene mixtures, for example by means of heterogeneous, Brønsted-acid catalysts such as those used in the PolyGas® process or EMOGAS® process, by means of the Dimersol® process with use of nickel complex catalysts homogeneously dissolved in the reaction medium, or by means of heterogeneous, nickel(II)-oxide-containing catalysts by the Octol® process or by the process of WO 9514647. The resultant isooctene mixtures are converted to isononanol mixtures by the known processes explained above in connection with the production of heptanol isomer mixtures, by means of rhodium or cobalt-catalyzed hydroformylation, preferably cobalt-catalyzed hydroformylation. These are then hydrogenated to give the suitable isononanol mixtures, for example by means of one of the catalysts mentioned above in connection with the production of isoheptanol.

The resultant isononanol isomer mixtures can be characterized by way of their iso-index, which can be calculated from the degree of branching of the individual, isomeric isononanol components in the isononanol mixture multiplied by the percentage proportion of these in the isononanol mixture: by way of example, n-nonanol contributes the value 0 to the iso-index of an isononanol mixture, methyloctanols (single branching) contribute the value 1, and dimethylheptanols (double branching) contribute the value 2. The higher the linearity, the lower the iso-index of the relevant isononanol mixture. Accordingly, the iso-index of an isononanol mixture can be determined via gas-chromatographic separation of the isononanol mixture into its individual isomers and attendant quantification of the percentage quantitative proportion of these in the isononanol mixture, determined by standard methods of gas-chromatographic analysis. In order to increase the volatility of the isomeric nonanols and improve the gas-chromatographic separation of these, they are advantageously trimethylsilylated by means of standard methods, for example via reaction with N-methyl-N-trimethylsilyltrifluoroacetamide, prior to gas-chromatographic analysis. In order to achieve maximum quality of separation of the individual components during gas-chromatographic analysis, it is preferable to use capillary columns with polydimethylsiloxane as stationary phase. Capillary columns of this type are obtainable commercially, and a little routine experimentation by the person skilled in the art is all that is needed in order to select, from the many different products available commercially, one that has ideal suitability for this separation task.

The diisononyl esters of the general formula (II) used in the plasticizer composition of the invention have generally been esterified with isononanols with an iso index of from 0.8 to 2, preferably from 1.0 to 1.8, and particularly preferably from 1.1 to 1.5, which can be produced by the abovementioned processes.

Possible compositions of isononanol mixtures that can be used for the production of the compounds of the general formula (II) used in accordance with the invention are stated below merely by way of example, and it should be noted here that the proportions of the isomers individually listed within the isononanol mixture can vary, depending on the composition of starting material, for example raffinate II, the composition of butenes in which can vary with the production process, and on variations in the production conditions used, for example the age of the catalysts utilized, and conditions of temperature and of pressure, which have to be adjusted appropriately thereto.

By way of example, an isononanol mixture produced via cobalt-catalyzed hydroformylation and subsequent hydrogenation from an isooctene mixture produced with use of raffinate II as raw material by means of the catalyst and process in accordance with WO 9514647 can have the following composition:
from 1.73 to 3.73% by weight, preferably from 1.93 to 3.53% by weight, particularly preferably from 2.23 to 3.23% by weight of 3-ethyl-6-methyl-hexanol;
from 0.38 to 1.38% by weight, preferably from 0.48 to 1.28% by weight, particularly preferably from 0.58 to 1.18% by weight of 2,6-dimethylheptanol;
from 2.78 to 4.78% by weight, preferably from 2.98 to 4.58% by weight, particularly preferably from 3.28 to 4.28% by weight of 3,5-dimethylheptanol;
from 6.30 to 16.30% by weight, preferably from 7.30 to 15.30% by weight, particularly preferably from 8.30 to 14.30% by weight of 3,6-dimethylheptanol;
from 5.74 to 11.74% by weight, preferably from 6.24 to 11.24% by weight, particularly preferably from 6.74 to 10.74% by weight of 4,6-dimethylheptanol;
from 1.64 to 3.64% by weight, preferably from 1.84 to 3.44% by weight, particularly preferably from 2.14 to 3.14% by weight of 3,4,5-trimethylhexanol;
from 1.47 to 5.47% by weight, preferably from 1.97 to 4.97% by weight, particularly preferably from 2.47 to 4.47% by weight of 3,4,5-trimethylhexanol, 3-methyl-4-ethylhexanol and 3-ethyl-4-methylhexanol;
from 4.00 to 10.00% by weight, preferably from 4.50 to 9.50% by weight, particularly preferably from 5.00 to 9.00% by weight of 3,4-dimethylheptanol;
from 0.99 to 2.99% by weight, preferably from 1.19 to 2.79% by weight, particularly preferably from 1.49 to 2.49% by weight of 4-ethyl-5-methylhexanol and 3-ethylheptanol;
from 2.45 to 8.45% by weight, preferably from 2.95 to 7.95% by weight, particularly preferably from 3.45 to 7.45% by weight of 4,5-dimethylheptanol and 3-methyloctanol;
from 1.21 to 5.21% by weight, preferably from 1.71 to 4.71% by weight, particularly preferably from 2.21 to 4.21% by weight of 4,5-dimethylheptanol;
from 1.55 to 5.55% by weight, preferably from 2.05 to 5.05% by weight, particularly preferably from 2.55 to 4.55% by weight of 5,6-dimethylheptanol;
from 1.63 to 3.63% by weight, preferably from 1.83 to 3.43% by weight, particularly preferably from 2.13 to 3.13% by weight of 4-methyloctanol;
from 0.98 to 2.98% by weight, preferably from 1.18 to 2.78% by weight, particularly preferably from 1.48 to 2.48% by weight of 5-methyloctanol;
from 0.70 to 2.70% by weight, preferably from 0.90 to 2.50% by weight, particularly preferably from 1.20 to 2.20% by weight of 3,6,6-trimethylhexanol;
from 1.96 to 3.96% by weight, preferably from 2.16 to 3.76% by weight, particularly preferably from 2.46 to 3.46% by weight of 7-methyloctanol;
from 1.24 to 3.24% by weight, preferably from 1.44 to 3.04% by weight, particularly preferably from 1.74 to 2.74% by weight of 6-methyloctanol;
from 0.1 to 3% by weight, preferably from 0.2 to 2% by weight, particularly preferably from 0.3 to 1% by weight of n-nonanol;
from 25 to 35% by weight, preferably from 28 to 33% by weight, particularly preferably from 29 to 32% by weight of other alcohols having 9 and 10 carbon atoms; with the proviso that the entirety of the components mentioned gives 100% by weight.

In accordance with what has been said above, an isononanol mixture produced via cobalt-catalyzed hydroformylation and subsequent hydrogenation with use of an isooctene mixture produced by means of the PolyGas® process or EMOGAS® process with an ethylene-containing butene mixture as raw material can vary within the range of the compositions below, depending on the composition of the raw material and variations in the reaction conditions used:
from 6.0 to 16.0% by weight, preferably from 7.0 to 15.0% by weight, particularly preferably from 8.0 to 14.0% by weight of n-nonanol;
from 12.8 to 28.8% by weight, preferably from 14.8 to 26.8% by weight, particularly preferably from 15.8 to 25.8% by weight of 6-methyloctanol;
from 12.5 to 28.8% by weight, preferably from 14.5 to 26.5% by weight, particularly preferably from 15.5 to 25.5% by weight of 4-methyloctanol;
from 3.3 to 7.3% by weight, preferably from 3.8 to 6.8% by weight, particularly preferably from 4.3 to 6.3% by weight of 2-methyloctanol;
from 5.7 to 11.7% by weight, preferably from 6.3 to 11.3% by weight, particularly preferably from 6.7 to 10.7% by weight of 3-ethylheptanol;
from 1.9 to 3.9% by weight, preferably from 2.1 to 3.7% by weight, particularly preferably from 2.4 to 3.4% by weight of 2-ethylheptanol;
from 1.7 to 3.7% by weight, preferably from 1.9 to 3.5% by weight, particularly preferably from 2.2 to 3.2% by weight of 2-propylhexanol;
from 3.2 to 9.2% by weight, preferably from 3.7 to 8.7% by weight, particularly preferably from 4.2 to 8.2% by weight of 3,5-dimethylheptanol;
from 6.0 to 16.0% by weight, preferably from 7.0 to 15.0% by weight, particularly preferably from 8.0 to 14.0% by weight of 2,5-dimethylheptanol;
from 1.8 to 3.8% by weight, preferably from 2.0 to 3.6% by weight, particularly preferably from 2.3 to 3.3% by weight of 2,3-dimethylheptanol;
from 0.6 to 2.6% by weight, preferably from 0.8 to 2.4% by weight, particularly preferably from 1.1 to 2.1% by weight of 3-ethyl-4-methylhexanol;
from 2.0 to 4.0% by weight, preferably from 2.2 to 3.8% by weight, particularly preferably from 2.5 to 3.5% by weight of 2-ethyl-4-methylhexanol;
from 0.5 to 6.5% by weight, preferably from 1.5 to 6% by weight, particularly preferably from 1.5 to 5.5% by weight of other alcohols having 9 carbon atoms; with the proviso that the entirety of the components mentioned gives 100% by weight.

### Decanol

Isodecanol, which is used for the synthesis of the diisodecyl esters of the general formula (II) comprised in the plasticizer composition of the invention, is not a unitary chemical compound, but instead is a complex mixture of differently branched isomeric decanols.

These are generally produced via nickel- or Brønsted-acid-catalyzed trimerization of propylene, for example by the PolyGas® process or the EMOGAS® process explained above, subsequent hydroformylation of the resultant isononene isomer mixture by means of homogeneous rhodium or cobalt carbonyl catalysts, preferably by means of cobalt carbonyl catalysts, and hydrogenation of the resultant isodecanal isomer mixture, e.g. by means of the catalysts and processes mentioned above in connection with the production of C₇-C₉-alcohols (Ullmann's Encyclopedia of Industrial Chemistry; 5^{th} edition, vol. A1, p. 293, VCH Verlagsgesellschaft GmbH, Weinheim 1985). The resultant isodecanol generally has a high degree of branching.

2-Propylheptanol, which is used for the synthesis of the di(2-propylheptyl) esters of the general formula (II) comprised in the plasticizer composition of the invention, can be pure 2-propylheptanol or can be propylheptanol isomer mixtures of the type generally formed during the Industrial production of 2-propylheptanol and likewise generally termed 2-propylheptanol.

Pure 2-propylheptanol can be obtained via aldol condensation of n-valeraldehyde and subsequent hydrogenation of the resultant 2-propylheptanol, for example in accordance with U.S. Pat. No. 2,921,089. By virtue of the production process, commercially obtainable 2-propylheptanol generally comprises, alongside the main component 2-propylheptanol, one or more of the following isomers of 2-propylheptanol: 2-propyl-4-methylhexanol, 2-propyl-5-methylhexanol, 2-isopropylheptanol, 2-isopropyl-4-methyl-hexanol, 2-isopropyl-5-methylhexanol, and/or 2-propyl-4,4-dimethylpentanol. The presence of other isomers of 2-propylheptanol, for example 2-ethyl-2,4-dimethylhexanol, 2-ethyl-2-methylheptanol, and/or 2-ethyl-2,5-dimethylhexanol, in the 2-propylheptanol is possible, but because the rates of formation of the aldehydic precursors of these isomers in the aldol condensation are low, the amounts of these present in the 2-propylheptanol are only trace amounts, if they are present at all, and they play practically no part in determining the plasticizer properties of the compounds produced from these 2-propylheptanol isomer mixtures.

Various hydrocarbon sources can be utilized as starting material for the production of 2-propylheptanol, for example 1-butene, 2-butene, raffinate I—an alkane/alkene mixture which is obtained from the C₄ cut of a cracker after removal of allenes, of acetylenes, and of dienes and which also comprises, alongside 1- and 2-butene, considerable amounts of isobutene—or raffinate II, which is obtained from raffinate I via removal of isobutene and then comprises, as olefin components other than 1- and 2-butene, only small proportions of isobutene. It is also possible, of course, to use mixtures of raffinate I and raffinate II as raw material for the production of 2-propylheptanol. These olefins or olefin mixtures can be hydroformylated by methods that are conventional per se with cobalt or rhodium catalysts, and 1-butene here gives a mixture of n- and isovaleradehyde—the term isovaleraldehyde designating the compound 2-methylbutanal, the n/Iso ratio of which can vary within relatively wide limits, depending on catalyst used and on hydroformylation conditions. By way of example, when a triphenylphosphine-modified homogeneous rhodium catalyst (Rh/TPP) is used, n- and isovaleraldehyde are formed in an n/iso ratio that is generally from 10:1 to 20:1 from 1-butene, whereas when rhodium hydroformylation catalysts modified with phosphite ligands are used, for example in accordance with U.S. Pat. No. 5,288,918 or WO 05028407, or when rhodium hydroformylation catalysts modified with phosphoamidite ligands are used, for example in accordance with WO 0283695, n-valeraldehyde is formed almost exclusively. While the Rh/TPP catalyst system converts 2-butene only very slowly in the hydroformylation, and most of the 2-butene can therefore be reclaimed from the hydroformylation mixture, 2-butene is successfully hydroformylated with the phosphite-ligand- or phosphorus amidite ligand-modified rhodium catalysts mentioned, the main product formed being n-valeraldehyde. In contrast, isobutene comprised within the olefinic raw material is hydroformylated at varying rates by practically all catalyst systems to 3-methylbutanal and, in the case of some catalysts, to a lesser extent to pivalaldehyde.

The C₅ aldehydes obtained in accordance with starting materials and catalysts used, i.e., n-valeraldehyde optionally mixed with isovaleraldehyde, 3-methylbutanal, and/or pivalaldehyde, can be separated, if desired, completely or to some extent by distillation into the individual components prior to the aldol condensation, and here again there is therefore a possibility of influencing and of controlling the composition of isomers of the C₁₀ alcohol component of the ester mixtures used in the process of the invention. Equally, it is possible that the C₅ aldehyde mixture formed during the hydroformylation is introduced into the aldol condensation without prior isolation of individual isomers. If n-valeraldehyde is used in the aldol condensation, which can be carried out by means of a basic catalyst, for example an aqueous solution of sodium hydroxide or of potassium hydroxide, for example by the processes described in EP-A 366089, U.S. Pat. No. 4,426,524, or U.S. Pat. No. 5,434,313, 2-propylheptanol is produced as sole condensate, whereas if a mixture of isomeric C₅ aldehydes is used the product comprises an Isomer mixture of the products of the homoaldol condensation of identical aldehyde molecules and of the crossed aldol condensation of different valeraldehyde isomers. The aldol condensation can, of course, be controlled via targeted reaction of individual isomers in such a way that a single aldol condensation isomer is formed predominantly or entirely. The relevant aldol condensates can then be hydrogenated with conventional hydrogenation catalysts, for example those mentioned above for the hydrogenation of aldehydes, to give the corresponding alcohols or alcohol mixtures, usually after preceding, preferably distillative isolation from the reaction mixture and, if desired, distillative purification.

As mentioned above, the compounds of the general formula (II) comprised in the plasticizer composition of the invention can have been esterified with pure 2-propylheptanol. However, production of said esters generally uses mixtures of 2-propylheptanol with the propylheptanol isomers mentioned in which the content of 2-propylheptanol is at least 50% by weight, preferably from 60 to 98% by weight, and particularly preferably from 80 to 95% by weight, in particular from 85 to 95% by weight.

Suitable mixtures of 2-propylheptanol with the propylheptanol isomers comprise by way of example those of from 60 to 98% by weight of 2-propylheptanol, from 1 to 15% by weight of 2-propyl-4-methylhexanol, and from 0.01 to 20% by weight of 2-propyl-5-methylhexanol, and from 0.01 to 24% by weight of 2-isopropylheptanol, where the sum of the proportions of the individual constituents does not exceed 100% by weight. It is preferable that the proportions of the individual constituents give a total of 100% by weight.

Other suitable mixtures of 2-propylheptanol with the propylheptanol isomers comprise by way of example those of from 75 to 95% by weight of 2-propylheptanol, from 2 to 15% by weight of 2-propyl-4-methylhexanol, from 1 to 20% by weight of 2-propyl-5-methylhexanol, from 0.1 to 4% by weight of 2-isopropylheptanol, from 0.1 to 2% by weight of 2-isopropyl-4-methylhexanol, and from 0.1 to 2% by weight of 2-isopropyl-5-methylhexanol, where the sum of the proportions of the individual constituents does not exceed 100% by weight. It is preferable that the proportions of the Individual constituents give a total of 100% by weight.

Preferred mixtures of 2-propylheptanol with the propylheptanol isomers comprise those with from 85 to 95% by weight of 2-propylheptanol, from 5 to 12% by weight of 2-propyl-4-methylhexanol, and from 0.1 to 2% by weight of 2-propyl-5-methylhexanol, and from 0.01 to 1% by weight of 2-isopropylheptanol, where the sum of the proportions of the individual constituents does not exceed 100% by weight. It is preferable that the proportions of the individual constituents give a total of 100% by weight.

When the 2-propylheptanol isomer mixtures mentioned are used instead of pure 2-propylheptanol for the production of the compounds of the general formula (II), the isomer composition of the alkyl ester groups and, respectively, alkyl ether groups corresponds in practical terms to the composition of the propylheptanol isomer mixtures used for the esterification.

### Undecanol

The undecanols, which are used for the production of the compounds of the general formula (II) comprised in the plasticizer composition of the invention, can be straight-chain or branched, or can be composed of mixtures of straight-chain and branched undecanols. It is preferable to use, as alcohol component, mixtures of branched undecanols, also termed isoundecanol.

Substantially straight-chain undecanol can be obtained via rhodium- or preferably cobalt-catalyzed hydroformylation of 1-decene and subsequent hydrogenation of the resultant n-undecanal. The starting olefin 1-decene is produced by way of the SHOP process mentioned previously for the production of 1-octene.

For the production of branched isoundecanol, the 1-decene obtained in the SHOP process can be subjected to skeletal isomerization, for example by means of acidic zeolitic molecular sieves, as described in WO 9823566, in which case mixtures of isomeric decenes are formed, rhodium- or preferably cobalt-catalyzed hydroformylation of which, with subsequent hydrogenation of the resultant isoundecanol mixtures, gives the isoundecanol used in the production of the compounds (II) employed in accordance with the invention. Hydroformylation of 1-decene or of isodecene mixtures by means of rhodium or cobalt catalysis can be achieved as described previously in connection with the synthesis of C₇-C₁₀ alcohols. Similar considerations apply to the hydrogenation of n-undecanal or of isoundecanal mixtures to give n-undecanol and, respectively, isoundecanol.

After distillative purification of the hydrogenation product, the resultant C₇-C₁₁ alkyl alcohols or a mixture of these can be used as described above for the production of the diester compounds of the general formula (II) used in the invention.

### Dodecanol

Substantially straight-chain dodecanol can be obtained advantageously by way of the Alfol® process or Epal® process. These processes include the oxidation and hydrolysis of straight-chain trialkylaluminum compounds which are constructed stepwise by way of a plurality of ethylation reactions, starting from triethylaluminum, with use of Ziegler-Natta catalysts. The desired n-dodecanol can be obtained from the resultant mixtures of substantially straight-chain alkyl alcohols of varying chain length after distillative discharge of the C₁₂ alkyl alcohol fraction.

Alternatively, n-dodecanol can also be produced via hydrogenation of natural fatty acid methyl esters, for example from coconut oil.

Branched isododecanol can be obtained by analogy with the known processes for the codimerization and/or oligomerization of olefins as described, for example, in WO 0063151, with subsequent hydroformylation and hydrogenation of the isoundecene mixtures as described, for example, in DE-A 4339713. After distillative purification of the hydrogenation product, the resultant isododecanols or mixtures of these can be used as described above for the production of the diester compounds of the general formula (II) used in the invention.

### Plastisol Applications

As described above, the good gelling properties of the plasticizer composition of the invention makes it particularly suitable for the production of plastisols.

The invention therefore further provides the use of a plasticizer composition as defined above as plasticizer in a plastisol.

Plastisols can be produced from various plastics. In one preferred embodiment, the plastisols of the invention are PVC plastisols.

The content of plasticizer composition of the invention in the PVC plastisols is usually from 5 to 300 phr, preferably from 30 to 200 phr.

Plastisols are usually converted to the form of the finished product at ambient temperature via various processes, such as spreading process, screenprinting process, casting processes, for example the slush molding process or rotomolding process, dip-coating process, spray process, and the like. Gelling then takes place via heating, whereupon cooling gives a homogeneous product with relatively high or relatively low flexibility.

PVC plastisols are particularly suitable for the production of PVC foils, for the production of seamless hollow bodies and of gloves, and for use in the textile sector, e.g. for textile coatings.

The PVC plastisols based on the plasticizer composition of the invention are specifically suitable for the production of synthetic leather, e.g. of synthetic leather for motor vehicle construction; underbody protection for motor vehicles; seam seals; carpet-backing coatings; high-weight coatings; conveyor belts; dip coatings, and items produced by means of dip processes; toys, such as dolls, balls, and toy animals; anatomical models for educational uses; floorcoverings; wallcoverings; (coated) textiles, for example latex apparel, protective apparel, and rainproof apparel, for example rainproof jackets; tarpaulins; roofing membranes; tents; strip coatings; sealing compositions for closures; respiratory masks, and gloves.

### Molding Composition Applications

The molding composition of the invention is preferably used for the production of moldings and foils. Among these are in particular housings of electrical devices, for example of kitchen appliances, and computer housings; tooling; equipment; piping; cables; hoses, for example plastics hoses, water hoses and irrigation hoses, industrial rubber hoses, or chemicals hoses; wire sheathing; window profiles; vehicle-construction components, for example bodywork constituents, vibration dampers for engines; tires; furniture, for example chairs, tables, or shelving; cushion foam and mattress foam; gaskets; composite foils, such as foils for laminated safety glass, in particular for vehicle windows and/or window panes; recording disks; packaging containers; adhesive-tape foils, or coatings.

The molding composition of the invention is also suitable for the production of moldings and foils which come directly into contact with people or with foods. These are primarily medical products, hygiene products, packaging for food or drink, products for the interior sector, toys and child-care items, sports-and-leisure products, apparel, or fibers for textiles, and the like.

The medical products which can be produced from the molding composition of the invention are by way of example tubes for enteral nutrition and hemodialysis, breathing tubes, infusion tubes, infusion bags, blood bags, catheters, tracheal tubes, disposable syringes, gloves, or breathing masks.

The packaging that can be produced from the molding composition of the invention for food or drink is by way of example freshness-retention foils, food-or-drink hoses, drinking-water hoses, containers for storing or freezing food or drink, lid gaskets, closure caps, crown corks, or synthetic corks for wine.

The products which can be produced from the molding composition of the Invention for the Interior sector are by way of example ground-coverings, which can be of homogeneous structure or can be composed of a plurality of layers, for example of at least one foamed layer, examples being floorcoverings, sports floors, or luxury vinyl tiles (LVTs), synthetic leathers, wallcoverings, or foamed or unfoamed wallpapers, in buildings, or can be cladding or console covers in vehicles.

The toys and child-care items which can be produced from the molding composition of the invention are by way of example dolls, inflatable toys, such as balls, toy figures, animal figures, anatomic models for education, modeling clays, swimming aids, stroller covers, baby-changing mats, bedwarmers, teething rings, or bottles.

The sports-and-leisure products that can be produced from the molding composition of the invention are by way of example gymnastics balls or other balls, exercise mats, seat cushions, massage balls and massage rollers, shoes and shoe soles, air mattresses, or drinking bottles.

The apparel that can be produced from the molding compositions of the invention is by way of example rubber boots.

### Non-PVC Applications

The present invention also includes the use of the plasticizer composition of the invention as and/or in auxiliaries selected from: calendering auxiliaries; rheology auxiliaries; surfactant compositions, such as flow aids and film-forming aids, defoamers, antifoams, wetting agents, coalescing agents, and emulsifiers; lubricants, such as lubricating oils, lubricating greases, and lubricating pastes; quenchers for chemical reactions; phlegmatizing agents; pharmaceutical products; plasticizers in adhesives or sealants; impact modifiers, and standardizing additives.

The examples and the figures described below provide further explanation of the invention. These examples and figures are not to be understood as restricting the invention.

The examples and figures hereinafter use the following abbreviations:

DBA is di(n-butyl) adipate,
INB is isononyl benzoate,
IDB is isodecyl benzoate,
DOTP is di(2-ethylhexyl) terephthalate,
DINP is diisononyl phthalate,
phr is parts by weight per 100 parts by weight of polymer.

### EXAMPLES

Ingredients used in the examples are as follows:

| Ingredient | Manufacturer |
|---|---|
| Homopolymeric emulsion-PVC, | SolVin SA, Brussels, Belgium |
| Trade name Solvin ® 367 NC | |
| Homopolymeric emulsion-PVC, | Vinnolit GmbH, Ismaning, |
| Trade name Vinnolit ® P 70 | Germany |
| Isononyl benzoate (Abbreviation: INB), | Evonik, Marl, Germany |
| Trade name Vestinol ® INB | |
| Isodecyl benzoate (Abbreviation: IDB), | Exxonmobil Chemical Belgium, |
| Trade name Jayflex ® MB 10 | Antwerp, Belgium |
| Di(2-ethylhexyl) terephthalate (Abb.: | Eastman Chemical B.V., Capelle |
| DOTP), | aan den Ijssel, The Netherlands |
| Trade name Eastman 168 ™ | |
| Diisononyl phthalate (Abbreviation: | BASF SE, Ludwigshafen, |
| DINP), | Germany |
| Trade name Palatinol ® N | |
| Ba—Zn stabilizer, | Reagens S.p.A., Bologna, Italy |
| Trade name Reagens ® SLX/781 | |

### I) Preparation of an Inventively Employed Compound (I):

### Example 1

### Synthesis of Di(n-Butyl) Adipate (Abbreviation: DBA) by Direct Esterification

A 2 L round-neck flask equipped with a Dean-Stark water separator and a dropping funnel with pressure compensation was charged with 445 g (6.00 mol, 4.0 equivalents) of n-butanol in 500 g of toluene. The mixture was heated with stirring to reflux and 219 g (1.50 mol, 1.0 equivalent) of adipic acid, followed by 11.5 g (0.12 mol, 8 mol %) of 99.9% strength sulfuric acid in 3 to 4 portions, were added whenever the reaction slowed down. The course of the reaction was monitored from the amount of water deposited in the Dean-Stark apparatus. Following complete conversion, a sample was taken from the reaction mixture and analyzed by GC. The reaction mixture was cooled to room temperature, transferred to a separating funnel, and washed twice with saturated NaHCO₃ solution. The organic phase was washed with saturated sodium chloride solution and dried over anhydrous Na₂SO₄ and the solvent was removed under reduced pressure. The crude product was purified by fractional distillation.

The resulting di-n-butyl adipate possesses a density of 0.960 g/cm³ (determined to DIN 51757), a viscosity of 6.0 mPa*s (to DIN 51562), a refractive index n_{D}²⁰ of 1.4350 (to DIN 51423), an acid number of 0.03 mg KOH/g (to DIN EN ISO 2114), a water content of 0.02% (to DIN 51777, Part 1), and a purity by GC of 99.86%.

### II) Performance Tests:

### II.a) Determination of Solvation Temperature to DIN 53408:

For characterizing the gelling performance of the inventively employed compounds (I) in PVC, the solvation temperature was determined in accordance with DIN 53408. According to DIN 53408, one drop of a suspension of 1 g of PVC in 19 g of plasticizer is observed in transmitted light under a microscope equipped with a heatable microscope stage. Starting at 60° C., the temperature is raised linearly by 2° C. per minute. The solvation temperature is taken to be the temperature at which the PVC particles become invisible, meaning that their contours and contrasts are no longer apparent. The lower the solvation temperature, the better the gelling performance of the substance in question for PVC.

The table below sets out the solvation temperatures of the inventively employed plasticizer di-n-butyl adipate and, for comparison, the solvation temperatures of the commercially available fast fusers isononyl benzoate (INB), trade name Vestinol® INB, isodecyl benzoate (IDB), trade name Jayflex® MB 10, the commercially available plasticizers di(2-ethylhexyl) terephthalate (DOTP), trade name Eastman 168™, and diisononyl phthalate (DINP), trade name Palatinol® N.

| | | Solvation temperature to |
|---|---|---|
| Ex. No. | Substance | DIN 53408 [° C.] |
| 1 | Di(n-butyl) adipate | 119 |
| C1 | Vestinol ® INB | 128 |
| C2 | Jayflex ® MB 10 | 131 |
| C3 | Eastman 168 ™ | 144 |
| C4 | Palatinol ® N | 131 |

As can be seen from the table, the Inventively employed fast fuser di-n-butyl adipate shows a much lower solvation temperature for PVC than the two commercially available fast fusers INB (Vestinol® INB) and IDB (Jayflex® MB 10) or the two commercially available plasticizers DOTP (Eastman 168™) and DINP (Palatinol® N).

### II.b) Determination of Gelling Performance of PVC Plastisols Comprising the Inventive Plasticizer Composition:

To investigate the gelling performance of PVC plastisols based on the inventive plasticizer compositions, PVC plastisols were produced, according to the formula below, comprising mixtures of the commercially available plasticizers DOTP (Eastman 168™) with the fast fuser DBA (di-n-butyl adipate) (8% and 10% by weight of di-n-butyl adipate, based on the plasticizer composition used):

| | Proportion |
|---|---|
| Ingredient | [phr] |
| PVC (mixture of 70 parts by weight homopolymeric | 100 |
| emulsion-PVC, trade name Solvin ® 367 NC, and 30 parts | |
| by weight homopolymeric emulsion-PVC, trade name | |
| Vinnolit ® P 70) | |
| Inventive plasticizer composition | 100 |
| Ba—Zn stabilizer, Reagens ® SLX/781 | 2 |

For comparison, moreover, plastisols were produced that contained exclusively the commercially available plasticizers DOTP (Eastman 168™) or DINP (Palatinol® N).

The plastisols were produced by weighing out the two PVC grades together in a PE (polyethylene) beaker. The liquid components were weighed out into a second PE beaker. A dissolver (Jahnke & Kunkel, IKA-Werk, Model RE-166 A, 60-6000 1/min, dissolver disk diameter=40 mm) was used at 400 rpm to stir the PVC Into the liquid components. When a plastisol had formed, the speed was increased to 2500 1/min and homogenization carried out for 150 seconds. The plastisol was transferred from the PE beaker into a steel dish, which was subjected to a pressure of 10 mbar in a desiccator. The aim of this is to remove the air in the plastisol. The plastisol expands to a greater or lesser extent in line with the air content. At this stage, the desiccator is shaken to disrupt the surface of the plastisol and cause it to collapse. From this point in time onward, the plastisol is left in the desiccator under a pressure of 10 mbar for a further 15 minutes. Then the vacuum pump is switched off, air is admitted to the desiccator and the plastisol is transferred back into the PE beaker. The plastisol is now ready for the rheological measurements. For all plastisols, measurement began 30 minutes after homogenization.

To gel a liquid PVC plastisol and to convert from the state of PVC particles homogenously dispensed in plasticizer into a homogeneous, solid plasticized-PVC matrix, the energy needed must be supplied in the form of heat. In a processing operation, the parameters of temperature and residence time are available for this purpose. The quicker gelling proceeds (the indicator here is the solvation temperature—the lower this temperature, the quicker the material gels), the lower the temperature (for a given residence time) or the residence time (for a given temperature) that can be selected.

The gelling performance of a plastisol is investigated by an in-house method using an MCR101 rheometer from Anton Paar. The parameter measured here is the viscosity of the paste while heating with constant low shear (oscillation). Parameters used for the oscillation tests were as follows:

| | |
|---|---|
| Measuring system: | Parallel plates, 50 mm diameter |
| Amplitude (gamma): | 1% |
| Frequency: | 1 Hz |
| Gap width: | 1 mm |
| Initial temperature: | 20° C. |
| Temperature profile: | 20° C.-200° C. |
| Heating rate: | 10° C./min |
| Number of measurement points: | 201 |
| Duration of each measurement point: | 0.09 min |

Measurement took place in two steps. The first step is used merely to condition the sample. At 20° C., the plastisol is subjected to gentle shearing for 2 minutes at constant amplitude (gamma=1%). In the second step, the temperature program begins. During the measurement, the storage modulus and the loss modulus are recorded. From these two variables, the complex viscosity η* is computed. The temperature at which the maximum of the complex viscosity is attained is termed the gelling temperature of the plastisol.

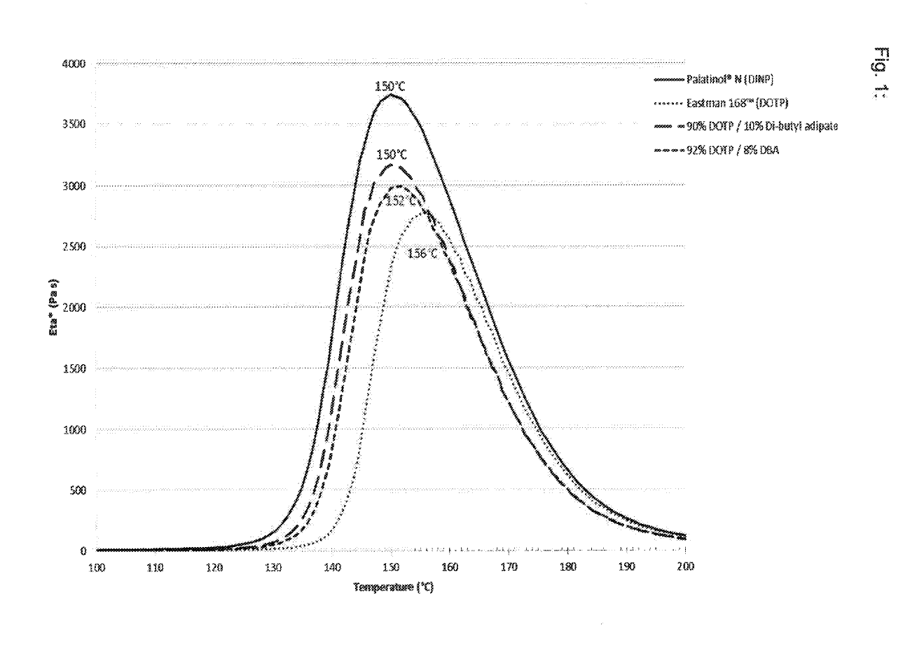

As is very clear from FIG. 1, the PVC plastisols with the inventive plasticizer composition gel at significantly lower temperatures than the PVC plastisol comprising exclusively the commercially available plasticizer DOTP (Eastman 168™). For a composition of just 90% DOTP (Eastman 168™) and 10% DBA (di-n-butyl adipate), a gelling temperature is achieved, of 150° C., which matches the gelling temperature of the commercially available plasticizer DINP (Palatinol® N) and which is sufficient for numerous plastisol applications. By raising the fraction of the fast fuser DBA (di-n-butyl adipate) in the plasticizer composition it is possible to achieve further marked lowering of the gelling temperature of the plastisol.

### II.c) Determining the Gelling Performance of PVC Plastisols Based on the Inventive Plasticizer Composition in Comparison to PVC Plastisols Comprising Conventional Fast Fusers:

In order to compare the gelling performance of PVC plastisols comprising the inventive plasticizer compositions with PVC plastisols comprising plasticizer compositions made up of conventional fast fusers, a method analogous to that described in II.b) was employed. In this case, first of all, for the conventional fast fusers isononyl benzoate (Vestinol® INB) and isodecyl benzoate (Jayfiex® MB 10), a determination was made of the mixing ratio with the commercially available plasticizer DOTP (Eastman 168™) that brings about a gelling temperature of 150° C., which is the gelling temperature of the commercially available plasticizer DINP (Palatinol® N).

For Vestinol® INB this mixing ratio lies at 27% Vestinol® INB and 73% Eastman 168™, and for Jayfiex® MB 10 at 36% Jayflex® MB 10 and 64% Eastman 168™.

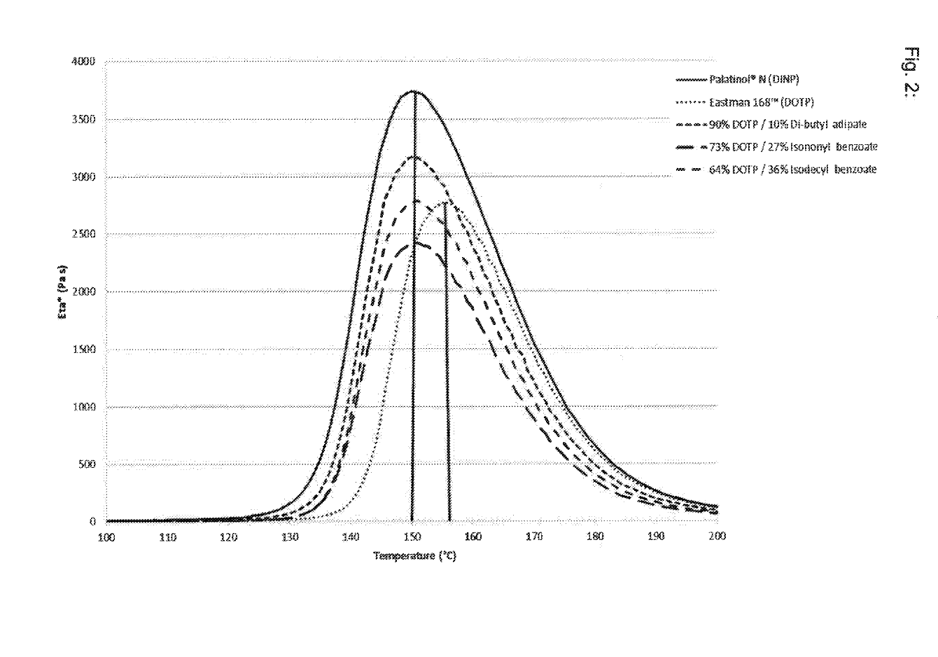

FIG. 2 compiles the gelling curves of the PVC plastisols with plasticizer compositions comprising the commercially available fast fusers Vestinol® INB and Jayflex® MB in comparison to the gelling curves of the PVC plastisols comprising the inventive plasticizer compositions. Included for comparison, moreover, are the gelling curves of the PVC plastisols comprising exclusively the commercially available plasticizers Eastman 168™ or Palatinol® N. From FIG. 2 it is very readily apparent that a fraction of the inventive fast fuser DBA (di-n-butyl adipate) in the inventive plasticizer compositions of just 10% is enough to obtain a gelling temperature of 150° C., which matches the gelling temperature of the commercially available plasticizer DINP (Palatinol® N) and which is sufficient for many plastisol applications. In contrast, in the case of the plasticizer compositions comprising the conventional fast fusers INB (Vestinol® INB) or IDB (Jayflex® MB), substantially higher fractions of 27% INB (Vestinol® INB) or 36% IDB (Jayflex® MB) are needed in order to obtain a plastisol gelling temperature of 150° C. Consequently the inventively employed fast fuser DBA (di-n-butyl adipate) possesses a much better gelling effect than the conventional fast fusers INB (Vestinol® INB) and IDB (Jayflex® MB 10).

II.d) Determining the Process Volatility of the Inventive Plasticizer Compositions in Comparison to Plasticizer Compositions with Conventional Fast Fusers

Process volatility refers to the weight loss of plasticizer during plastisol processing. As described under II.c), plastisols were produced that comprise the inventive plasticizer composition of 10% of the fast fuser DBA (di-n-butyl adipate) and 90% of the commercially available plasticizer DOTP (Eastman 168™), a plasticizer composition of 27% of the commercially available fast fuser INB (Vestinol® INB) and 73% of the commercially available plasticizer DOTP (Eastman 168™), and also 36% of the commercially available fast fuser IDB (Jayflex® MB 10) and 64% of the commercially available plasticizer DOTP (Eastman 168™). The formula used was as follows.

| | Proportion |
|---|---|
| Ingredient | [phr] |
| PVC (mixture of 70 parts by weight homopolymeric | 100 |
| emulsion-PVC, trade name Solvin ® 367 NC, and 30 parts | |
| by weight homopolymeric emulsion-PVC, trade name | |
| Vinnolit ® P 70) | |
| Plasticizer composition | 60 |
| Ba—Zn stabilizer, Reagens ® SLX/781 | 2 |

Produced for comparison, moreover, were plastisols comprising exclusively the commercially available plasticizers DOTP (Eastman 168™) or DINP (Palatinol® N).

### Production of a Foil Precursor:

In order to allow determination of the performance properties from the plastisols, the liquid plastisol must be converted to a processable solid foil. For this purpose, the plastisol is pre-gelled at lower temperature.

Gelling of the plastisols took place in a Mathis oven.

### Settings on the Mathis Oven:

Exhaust air: flap completely open
Fresh air open
Air circulation: maximum position
Upper air/lower air upper air setting 1

### Production Procedure:

A new relay paper was clamped into the Mathis oven's clamping apparatus. The oven is preheated to 140° C. and the gelling time is set to 25 s. The gap is set by using the thickness template to adjust the gap between paper and doctor to 0.1 mm. The dial gauge thickness is set to 0.1 mm. The gap is then adjusted to a value of 0.07 mm on the dial gauge.

The plastisol is applied to the paper and spread smoothly by the doctor. The clamping apparatus is then moved into the oven via the start button. After 25 s, the clamping apparatus is moved back out of the oven again. The plastisol has gelled, and the resultant foil can be therefore peeled in one piece from the paper. The thickness of this foil is about 0.5 mm.

### Determination of the Process Volatility:

Process volatility is determined by using a metal Shore hardness punch to punch 3 square test specimens (49×49 mm) in each case from the foil precursor, weighing these squares, and then gelling them in the Mathis oven at 190° C. for 2 minutes. After cooling, the specimens are weighed again and the weight loss in % is calculated. For this purpose, the specimens were always positioned exactly at the same location on the relay paper.

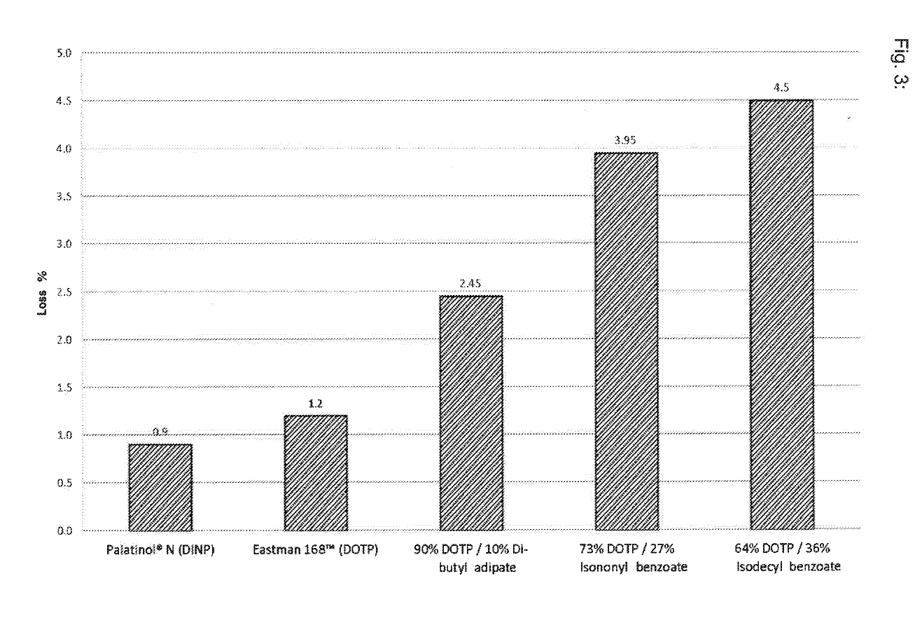

As can be seen very clearly from FIG. 3, the process volatility of the inventive plasticizer composition of 10% DBA (di-n-butyl adipate) and 90% DOTP (Eastman 168™) is much lower than the process volatility of the plasticizer compositions of 27% INB (Vestinol® INB) and 73% DOTP (Eastman 168™) and of 36% IDB (Jayflex® MB) and 64% DOTP (Eastman 168™). In the processing of the plastisols based on the inventive plasticizer compositions, therefore, much less plasticizer is lost.

The process volatility of the inventive plasticizer composition of 10% DBA (di-n-butyl adipate) and 90% DOTP (Eastman 168™) is higher, however, than that of the pure plasticizers DOTP (Eastman 168™) and, respectively, DINP (Palatinol® N).

II.e) Determination of the Shore a Hardness of Folis Produced from Plastisols Comprising the Inventive Plasticizer Compositions in Comparison to Foils Produced from Plastisols Comprising Plasticizer Compositions with Conventional Fast Fusers

The Shore A hardness is a measure of the elasticity of plasticized PVC articles. The lower the Shore hardness, the greater the elasticity of the PVC articles.

For the determination of the Shore A hardness, as described under II.d), foil sections measuring 49×49 mm were punched from the foil precursors and gelled in each case in groups of three at 190° C. for 2 minutes in the same way as for the volatility test. A total of 27 foil pieces were gelled in this way. These 27 pieces were placed atop one another in a pressing frame and pressed at 195° C. to give a Shore block 10 mm thick.

### Description of the Shore Hardness Measurement:

Method: DIN EN ISO 868, October 2003
Instrument used: Hildebrand DD-3 Digital Durometer
Specimens: 49 mm×49 mm×10 mm (length×width×thickness); pressed from about 27 gel foils 0.5 mm thick, at a temperature of 195° C.
Storage time of specimens before measurement: 7 days in climate chamber at 23° C. and 50% relative humidity
Measurement time: 15 s
10 individual values are measured and the average value calculated from them

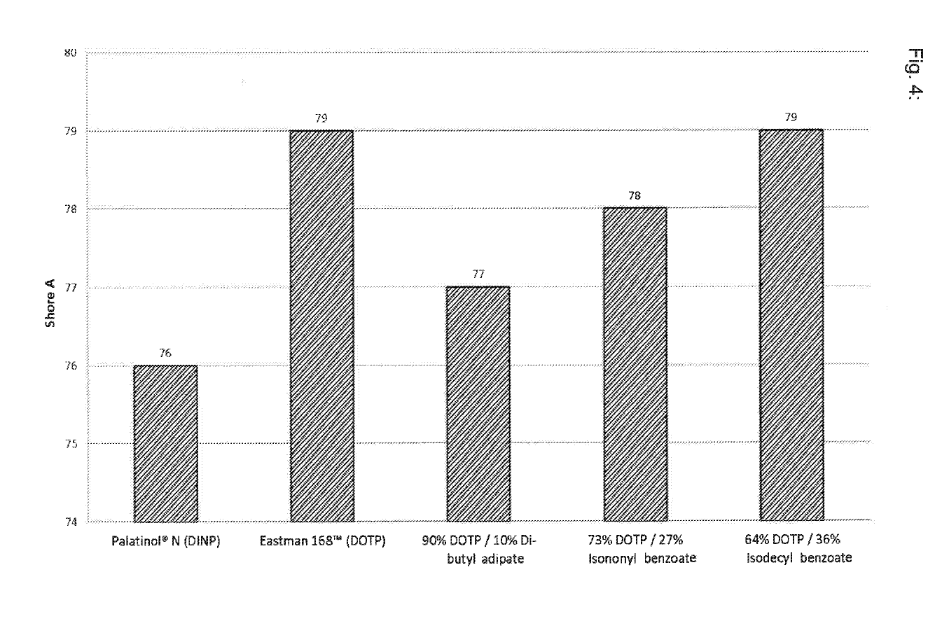

As is very clearly apparent from FIG. 4, the Shore A hardness of the foil made from the plastisol with the inventive plasticizer composition of 10% DBA (di-n-butyl adipate) and 90% DOTP (Eastman 168™) is much lower than the Shore A hardness of the foils made from the plastisols with the plasticizer compositions of 27% INB (Vestinol® INB) and 73% DOTP (Eastman 168™) and also of 36% IDB (Jayflex@ MB) and 64% DOTP (Eastman 168™). Using the inventive plasticizer compositions therefore gives a greater elasticity to the PVC articles.

Furthermore, the Shore A hardness of the foil made from the plastisol with the inventive plasticizer composition of 10% DBA (di-n-butyl adipate) and 90% DOTP (Eastman 168™) is also much lower than the Shore A hardness of the foil made from the plastisol with the pure plasticizer DOTP (Eastman 168™), but somewhat higher than the Shore A hardness of the foil made from the plastisol with the pure plasticizer DINP (Palatinol® N).

II.f) Determination of the Foil Volatility of Foils Produced from Plastisols Comprising Inventive Plasticizer Compositions, in Comparison to Foils Produced from Plastisols Comprising Plasticizer Compositions with Conventional Fast Fusers

The foil volatility is a measure of the volatility of a plasticizer in the finished plasticized PVC article. For the testing of foil volatility, as described under III.c), plastisols comprising the Inventive plasticizer composition of 10% of the fast fuser DBA (di-n-butyl adipate) and 90% of the commercially available plasticizer DOTP (Eastman 168™), a plasticizer composition of 27% of the commercially available fast fuser INB (Vestinol® INB) and 73% of the commercially available plasticizer DOTP (Eastman 168™), and a plasticizer composition of 36% of the commercially available fast fuser IDB (Jayflex@ MB 10) and 64% of the commercially available plasticizer DOTP (Eastman 168™) were produced. Produced for comparison, moreover, were plastisols comprising exclusively the commercially available plasticizers DOTP (Eastman 168™) or DINP (Palatinol® N). For the tests here, however, a foil precursor was not produced; instead, the plastisol was gelled directly in the Mathis oven at 190° C. for 2 minutes. The foil volatility test was carried out on the resultant foils, which had a thickness of approximately 0.5 mm.

### Testing of Foil Volatility Over 24 Hours at 130° C.:

For the determination of the foil volatility, four individual foils (150×100 mm) were cut from the plastisols gelled at 190° C. for 2 minutes, and were perforated and weighed. The foils are suspended from a rotating star inside a Heraeus 5042 E drying cabinet set at 130° C. Within the cabinet, the air is changed 18 times an hour. This corresponds to 800 l/h fresh air. After 24 hours in the cabinet, the foils are removed and weighed again. The weight loss in percent indicates the foil volatility of the plasticizer compositions.

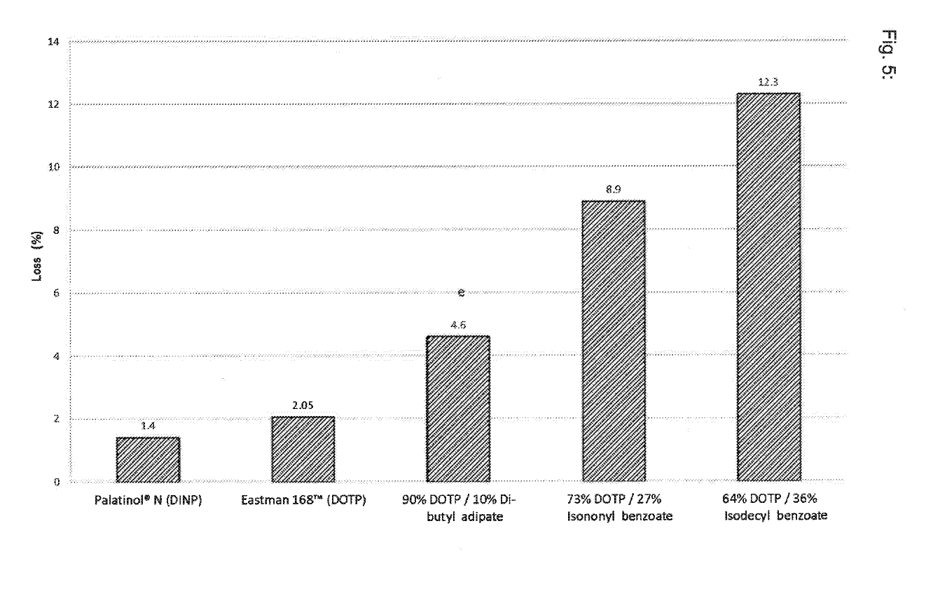

As can be seen very clearly from FIG. 5, the foil volatility of the inventive plasticizer composition of 10% DBA (di-n-butyl adipate) and 90% DOTP (Eastman 168™) is much lower than the foil volatility of the plasticizer compositions of 27% INB (Vestinol® INB) and DOTP (73% Eastman 168™) and also of 36% IDB (Jayflex® MB) and 64% DOTP (Eastman 168™). In the case of PVC foils comprising the inventive plasticizer compositions, therefore, less plasticizer escapes from the finished plasticized PVC article.

The foil volatility of the inventive plasticizer composition of 10% DBA (di-n-butyl adipate) and 90% DOTP (Eastman 168™) is, however, higher than that of the pure plasticizers DOTP (Eastman 168™) and, respectively, DINP (Palatinol® N).

II.g) Determination of the Mechanical Properties of Foils Produced from Plastisols Comprising the Inventive Plasticizer Composition, in Comparison to Foils Produced from Plastisols Comprising Plasticizer Compositions with Conventional Fast Fusers

The mechanical properties of plasticized PVC articles are characterized by way for example of the parameter of elongation at break. The higher this figure, the better the mechanical properties of the plasticized PVC article.

For the testing of the mechanical properties, plastisols comprising Inventive plasticizer composition of 10% of the fast fuser DBA (di-n-butyl adipate) and 90% of the commercially available plasticizer DOTP (Eastman 168™), a plasticizer composition of 27% of the fast fuser INB (Vestinol® INB) and 73% DOTP (Eastman 168™), and a plasticizer composition of 36% of the fast fuser IDB (Jayflex® MB 10) and 64% DOTP (Eastman 168™) were produced as described under II.c). For comparison, moreover, plastisols were produced which comprised exclusively the commercially available plasticizers DOTP (Eastman 168™) or DINP (Palatinol® N). For the tests here, however, rather than production first of a foil precursor, the plastisol was gelled directly in the Mathis oven at 190° C. for 2 minutes. The mechanical properties were tested on the resultant films, whose thickness was approximately 0.5 mm.

### Determination of Elongation at Break:

Method: Testing to DIN EN ISO 527 Part 1 and Part 3
Machine: Zwicki TMZ 2.5/TH1S
Specimens: Type 2 punched foil strips as per DIN EN ISO 527 Part 3, 150 mm long, 15 mm wide
Number of specimens per test: 10 samples
Conditions: Standard conditions 23° C. (+−1° C.), 50% relative humidity
Storage time of specimens prior to measurement: 7 days under standard conditions
Clamps: Smooth and convex with 6 bar clamping pressure
Clamped length: 100 mm
Measurement length (=clamped length): 100 mm
Test velocity: 100 mm/min

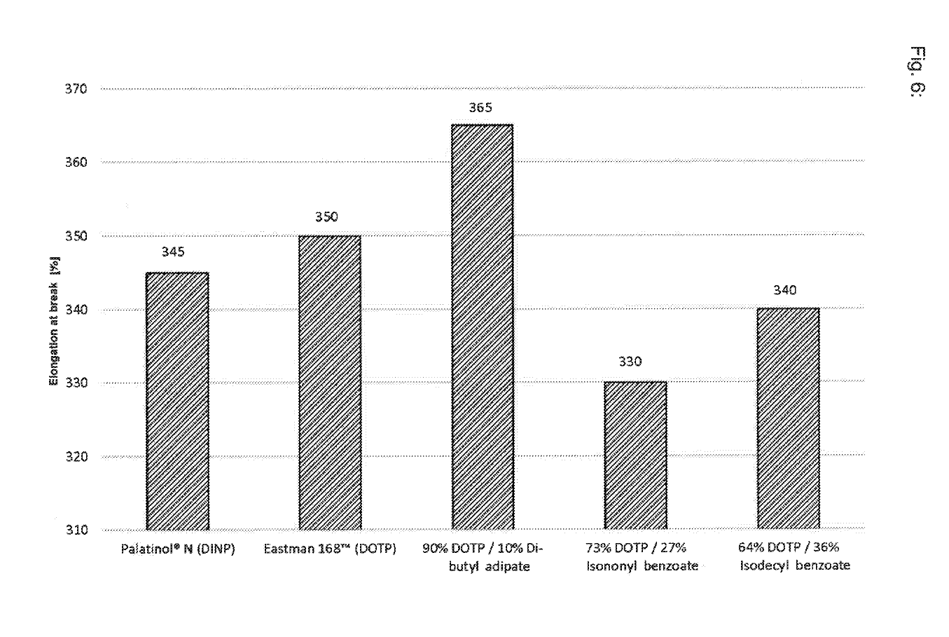

As can be seen very clearly from FIG. 6, the figure for the elongation at break for the foil produced from the plastisol comprising 10% DBA (di-n-butyl adipate) and 90% DOTP (Eastman 168™) is much higher than the figures for the foils produced from the plastisols comprising 27% INB (Vestinol® INB) and 73% DOTP (Eastman 168™) and also 36% IDB (Jayflex® MB) and 64% DOTP (Eastman 168™), and also than the figures for the foils produced from the plastisols comprising exclusively the pure plasticizers DOTP (Eastman 168™) and DINP (Palatinol® N).

II.h) Determination of the Compatibility (Permanence) of Foils Produced from Plastisols Comprising the Inventive Plasticizer Composition, in Comparison to Foils Produced from Plastisols Comprising Plasticizer Compositions with Conventional Fast Fusers

The compatibility (permanence) of plasticizers in plasticized PVC articles characterizes the extent to which plasticizers tend to exude from the plasticized PVC articles in use and so adversely affect the service properties of the PVC article.

For the testing of the compatibility (permanence), plastisols comprising inventive plasticizer composition of 10% of the fast fuser DBA (di-n-butyl adipate) and 90% of the commercially available plasticizer DOTP (Eastman 168™), a plasticizer composition of 27% of the fast fuser INB (Vestinol® INB) and 73% DOTP (Eastman 168™), and a plasticizer composition of 36% of the fast fuser IDB (Jayflex® MB 10) and 64% DOTP (Eastman 168™) were produced as described under II.c). For comparison, moreover, plastisols were produced which comprised exclusively the commercially available plasticizers DOTP (Eastman 168™) or DINP (Palatinol® N). For the tests here, however, rather than production first of a foil precursor, the plastisol was gelled directly in the Mathis oven at 190° C. for 2 minutes. The mechanical properties were tested on the resultant films, whose thickness was approximately 0.5 mm.

### Test Method:

### Purpose of Test Process:

The test is used to qualify and quantify the compatibility of flexible PVC formulations. It is carried out at elevated temperature (70° C.) and elevated atmospheric humidity (100% relative atmospheric humidity). The data obtained are evaluated against the storage time.

### Test Specimens:

The standard test is carried out using 10 test specimens (foils) per formulation having a size of 75×110×0.5 mm. The foils are perforated on the broad side, inscribed, and weighed. The inscription must be indelible and may be done for example with a soldering iron.

### Test Equipment:

Heating cabinet, analytical balance, thermometer with sensor for measuring the interior temperature of the heating cabinet, pond made from glass, metal rack made from rustproof material;

Test temperature: 70° C.

Test medium: water vapor produced at 70° C. from fully demineralized water

### Procedure:

The temperature in the interior of the heating cabinet is set to the required 70° C. The test foils are suspended on a wire rack and inserted into a glass tank filled to a height of about 5 cm with water (fully demineralized water). Only foils having the same composition may be stored in a labeled and numbered pond, in order to avoid interference and to facilitate removal after the respective storage times.

The glass tank is sealed with a polyethylene foil so as to be impervious to water vapor (I), so that the water vapor subsequently produced in the glass tank is unable to escape.

### Storage Time:

After a storage time of 1, 3, 7, 14 and 28 days, two foils (repeat determination) are taken from the glass tank and conditioned in the air for one hour, in free suspension. The foil is then cleaned in a fume hood using methanol (towel moistened with methanol) and weighed (wet value). The foil is subsequently dried, in free suspension, at 70° C. for 16 hours in a drying cabinet (natural convection). Following removal from the drying cabinet, the foil is conditioned for one hour in the laboratory in free suspension and then weighed again (dry value). The data reported in each case as test result is the arithmetic mean of the changes in weight.

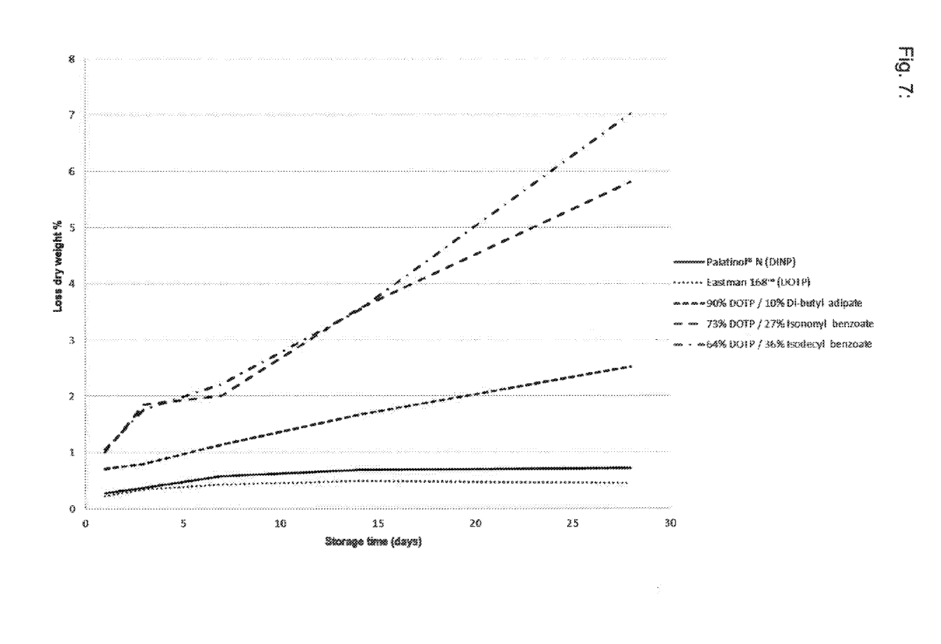

As is very clearly apparent from FIG. 7, the exudation behavior of the inventive plasticizer composition of 10% DBA (di-n-butyl adipate) and 90% DOTP (Eastman 168™) is much better than the exudation behavior of the plasticizer compositions of 27% INB (Vestinol® INB) and 73% DOTP (Eastman 168™) and also of 36% IDB (Jayflex® MB) and 64% DOTP (Eastman 168™), but poorer than the exudation behavior of the pure plasticizers DOTP (Eastman 168™) and DINP (Palatinol® N).

1.-22. (canceled)

23. A plasticizer composition comprising
a) at least one compound of the general formula (I),
R¹—O—C(═O)—X—C(═O)—O—R² (I)
in which
X is an unbranched or branched C₂-C₈ alkylene group or an unbranched or branched C₂-C₈ alkenylene group, comprising at least one double bond and
R¹ and R² independently at each occurrence are selected from C₃-C₅ alkyl,
b) at least one compound of the general formula (II), 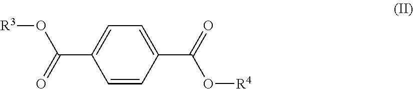
in which
R³ and R⁴ independently of one another are selected from branched and unbranched C₄-C₁₂ alkyl radicals.

24. The plasticizer composition according to claim 23, wherein X is an unbranched C₂-C₅ alkylene group.

25. The plasticizer composition according to claim 23, wherein R¹ and R² independently at each occurrence are n-butyl, isobutyl, n-pentyl, 2-methylbutyl or 3-methylbutyl.

26. The plasticizer composition according to claim 23, wherein R¹ is n-butyl.

27. The plasticizer composition according to claim 23, wherein R³ and R⁴ both being 2-ethylhexyl, both being isononyl or both being 2-propylheptyl.

28. The plasticizer composition according to claim 23, wherein the plasticizer further comprises a plasticizer which is different from the compounds (I) and (II) and said plasticizer is phthalic dialkyl esters, phthalic alkylaryl esters, cyclohexane-1,2-dicarboxylic esters, cyclohexane-1,4-dicarboxylic esters, trimellitic trialkyl esters, benzoic alkyl esters, dibenzoic esters of glycols, hydroxybenzoic esters, esters of saturated monocarboxylic acids, esters of saturated dicarboxylic acids other than compounds (I), esters of unsaturated dicarboxylic acids other than compounds (I), amides and esters of aromatic sulfonic acids, alkylsulfonic esters, glycerol esters, isosorbide esters, phosphoric esters, citric triesters, alkylpyrrolidone derivatives, 2,5-furandicarboxylic esters, 2,5-tetrahydrofurandicarboxylic esters, epoxidized vegetable oils, epoxidized fatty acid monoalkyl esters, polyesters of aliphatic and/or aromatic polycarboxylic acids with at least dihydric alcohols.

29. The plasticizer composition according to claim 23, wherein the amount of compounds of the general formula (I) in the plasticizer composition being 1 to 70 wt %.

30. The plasticizer composition according to claim 23, wherein the amount of compounds of the general formula (II) in the plasticizer composition being 30 to 99 wt %.

31. The plasticizer composition according to claim 23, wherein the weight ratio between compounds of the general formula (I) and compounds of the general formula (II) is in the range from 1:100 to 2:1.

32. A molding composition comprising at least one polymer and a plasticizer composition as claimed in claim 23.

33. The molding composition according to claim 32, wherein the polymer is a thermoplastic polymer selected from the group consisting of
homopolymers or copolymers comprising in copolymerized form at least one monomer selected from C₂-C₁₀ monoolefins, 1,3-butadiene, 2-chloro-1,3-butadiene, vinyl alcohol and its C₂-C₁₀ alkyl esters, vinyl chloride, vinylidene chloride, vinylidene fluoride, tetrafluoroethylene, glycidyl acrylate, glycidyl methacrylate, acrylates and methacrylates of C₁-C₁₀ alcohols, vinylaromatics, (meth)acrylonitrile, maleic anhydride, and α,β-ethylenically unsaturated monocarboxylic and dicarboxylic acids,
homopolymers and copolymers of vinyl acetals,
polyvinyl esters,
polycarbonates,
polyesters,
polyethers,
polyetherketones,
thermoplastic polyurethanes,
polysulfides,
polysulfones,
polyethersulfones,
cellulose alkyl esters
and mixtures thereof.

34. The molding composition according to claim 33, wherein the thermoplastic polymer is polyvinyl chloride (PVC), polyvinyl butyral (PVB), homopolymers and copolymers of vinyl acetate, homopolymers and copolymers of styrene, polyacrylates, thermoplastic polyurethanes (TPU) or polysulfides.

35. The molding composition according to claim 33, wherein the thermoplastic polymer is polyvinyl chloride (PVC).

36. The molding composition according to claim 35, the amount of the plasticizer composition in the molding composition being 1.0 to 300 phr.

37. The molding composition according to claim 33, comprising at least one thermoplastic polymer other than polyvinyl chloride, the amount of the plasticizer composition in the molding composition being 0.5 to 300 phr.

38. The molding composition according to claim 32, wherein the polymer is an elastomer, selected from the group consisting of natural rubbers, synthetic rubbers, and mixtures thereof.

39. The molding composition according to claim 38, the amount of the plasticizer composition in the molding composition being 1.0 to 60 phr.

40. A thermoplastic polymer or elastomer which comprises the composition as claimed in claim 32.

41. A plastisol which comprises the composition as claimed in claim 32.

42. The molding composition as defined in claim 32, wherein the molding composition is a housing of electrical device, computer housing, tooling, piping, cable, hose, wire sheathing, window profile, vehicle-construction component, tire, furniture, cushion foam and mattress foam, tarpaulin, gasket, composite foil, recording disk, synthetic leather, packaging container, adhesive-tape foil or coating.

43. A process for utilizing a molding composition or a foil which come directly into contact with people or with foods which comprises contacting the molding composition as defined in claim 32 with a person or a food.

44. The process as claimed in claim 43, wherein the moldings and foils which come directly into contact with humans or foods are medical products, hygiene products, packaging for food or drink, products for the interior sector, toys and child-care items, sports-and-leisure products, apparel, or fibers for textiles.
